(19) United States
(12) Patent Application Publication
(10) Pub. No.: US 2010/0013649 A1
(43) Pub. Date: Jan. 21, 2010

(54) LOAD CONTROL DEVICE HAVING AUDIBLE FEEDBACK

(76) Inventor: Joel S. Spira, Coopersburg, PA (US)

Correspondence Address: OSTROLENK FABER GERB & SOFFEN, 1180 AVENUE OF THE AMERICAS, NEW YORK, NY, 100368403, US

(21) Appl. No.: 12/506,623

(22) Filed: Jul. 21, 2009

Related U.S. Application Data
(63) Continuation-in-part of application No. 11/472,245, filed on Jun. 20, 2006, now Pat. No. 7,608,948.
Application No. 11/472,245 is a continuation-in-part of application No. 12/033,329, filed on Feb. 19, 2008.

(51) Int. Cl. G08B 21/00

(52) U.S. Cl. 340/664; 315/291

(57) ABSTRACT

A load control device for controlling the amount of power delivered from an AC power source to an electrical load comprises a non-visual, haptic sensory output structure for producing a variable human detectable output related to the amount of power being delivered to the load. Specifically, the load control device may comprise an audible sound generator for generating audible sounds having operational characteristics that are representative of the amount of power being delivered to the load. For example, the amplitude (or frequency) of the audible sounds may increase as the amount of power delivered to the load increases and may decrease as the amount of power delivered to the load decreases. The audible sound generator may generate a turn-on audible sound that increases in amplitude (or frequency) with respect to time when the load is turned on, and a turn-off audible sound that decreases in amplitude (or frequency) with respect to time when the load is turned off.

### CROSS-REFERENCE TO RELATED APPLICATIONS

This is a continuation-in-part of commonly-assigned, co-pending U.S. patent application Ser. No. 11/472,245, filed Jun. 20, 2006, entitled TOUCH SCREEN WITH SENSORY FEEDBACK. The present application is also a continuation-in-part of commonly-assigned, co-pending U.S. patent application Ser. No. 12/033,329, filed Feb. 19, 2006, entitled SMART LOAD CONTROL DEVICE HAVING A ROTARY ACTUATOR. The entire disclosures of both applications are hereby incorporated by reference.

### BACKGROUND OF THE INVENTION

1. Field of the Invention

The present invention relates to load control devices for controlling the amount of power delivered to an electrical load from a power source. More specifically, the present invention relates to a dimmer switch operable to provide audible feedback regarding the amount of power being delivered to a connected lighting load.

2. Description of the Related Art

A conventional two-wire dimmer has two terminals: a “hot” terminal for connection to an alternating-current (AC) power supply and a “dimmed hot” terminal for connection to a lighting load. Standard dimmers use one or more semiconductor switches, such as triacs or field effect transistors (FETs), to control the current delivered to the lighting load and thus to control the intensity of the light. The semiconductor switches are typically coupled between the hot and dimmed hot terminals of the dimmer.

Smart wall-mounted dimmers include a user interface typically having a plurality of buttons for receiving inputs from a user and a plurality of status indicators for providing feedback to the user. These smart dimmers typically include a microcontroller or other processing device for providing an advanced set of control features and feedback options to the end user. An example of a smart dimmer is described in greater detail in commonly assigned U.S. Pat. No. 5,248,919, issued on Sep. 28, 1993, entitled LIGHTING CONTROL DEVICE, the entire disclosure of which is hereby incorporated by reference.

FIG. 1 is a front view of a user interface of a prior art smart dimmer switch 10 for controlling the amount of power delivered from a source of AC power to a lighting load. As shown, the dimmer switch 10 includes a faceplate 12, a bezel 14, an intensity selection actuator 16 for selecting a desired level of light intensity of a lighting load (not shown) controlled by the dimmer switch 10, and a control switch actuator 18. Actuation of the upper portion 16A of the intensity selection actuator 16 increases or raises the light intensity of the lighting load, while actuation of the lower portion 16B of the intensity selection actuator 16 decreases or lowers the light intensity. The intensity selection actuator 16 may control a rocker switch, two separate push switches, or the like. The control switch actuator 18 may control a push switch or any other suitable type of actuator and typically provides tactile and auditory feedback to a user when pressed.

The smart dimmer 10 also includes an intensity level indicator in the form of a plurality of light sources 20, such as light-emitting diodes (LEDs). Light sources 20 may be arranged in an array (such as a linear array as shown) representative of a range of light intensity levels of the lighting load being controlled. The intensity level of the lighting load may range from a minimum intensity level (i.e., a low-end intensity) to a maximum intensity level (i.e., a high-end intensity). For example, the minimum intensity level is the lowest visible intensity (but may be zero, or “full off”), while the maximum intensity level is typically “full on”. Light intensity level is typically expressed as a percentage of full intensity. Thus, when the lighting load is on, light intensity level may range from 1% to 100%.

By illuminating a selected one of the light sources 20 depending upon light intensity level, the position of the illuminated light source within the array provides a visual indication of the light intensity relative to the range when the lamp or lamps being controlled are on. For example, seven LEDs are illustrated in FIG. 1. Illuminating the uppermost LED in the array will give an indication that the light intensity level is at or near maximum. Illuminating the center LED will give an indication that the light intensity level is at about the midpoint of the range. In addition, when the lamp or lamps being controlled are off, all of the light sources 18 are illuminated at a low level of illumination, while the LED representative of the present intensity level in the on state is illuminated at a higher illumination level. This enables the light source array to be more readily perceived by the eye in a darkened environment, which assists a user in locating the switch in a dark room, for example, in order to actuate the switch to control the lights in the room, and provides sufficient contrast between the level-indicating LED and the remaining LEDs to enable a user to perceive the relative intensity level at a glance.

Touch dimmers (or “zip” dimmers) are known in the art. A touch dimmer generally includes a touch-operated input device, such as a resistive or a capacitive touch pad. The touch-operated device responds to the force and position of a point actuation on the surface of the device and in turn controls the semiconductor switches of the dimmer. An example of a touch dimmer is described in greater detail in commonly-assigned U.S. Pat. No. 5,196,782, issued Mar. 23, 1993, entitled TOUCH-OPERATED POWER CONTROL, the entire disclosure of which is hereby incorporated by reference.

FIG. 2 is a cross-sectional view of a prior art touch-operated device 30, specifically, a membrane voltage divider. A conductive element 32 and a resistive element 34 are co-extensively supported in close proximity by a spacing frame 36. An input voltage, V_{IN}, is applied across the resistive element 34 to provide a voltage gradient across its surface. When pressure is applied at a point 38 along the conductive element 32 (by a finger or the like), the conductive element flexes downward and electrically contacts a corresponding point along the surface of the resistive element 34, providing an output voltage, V_{OUT}, whose value is between the input voltage V_{IN} and ground. When pressure is released, the conductive element 32 recovers its original shape and becomes electrically isolated from the resistive element 34. The touch-operated device 30 is characterized by a contact resistance R_{CONTACT} between the conductive element 32 and the resistive element 34. The contact resistance R_{CONTACT} is dependent upon the force of the actuation of the touch-operated device 30 and is typically substantially small for a normal actuation force.

FIG. 3 is a perspective view of a user interface of a prior art touch dimmer 40. The dimmer 40 comprises a touch-operated device 30, which is located directly behind a faceplate 42. The faceplate 42 includes a flexible area 44 located directly above the conductive element 32 of the touch-operated device 30 to permit a user to actuate the touch-operated device through the faceplate 42. A conventional phase-control dimming circuit is located within an enclosure 46 and controls the power from a source to a load in accordance with pressure applied to a selectable point on flexible area 44. The faceplate 42 may include optional markings 48, 50, 52 to indicate, respectively, the location of flexible area 44, the lowest achievable intensity level of the load, and location of a “power off” control. An optional LED array 54 provides a visual indication of intensity level of the load. When the load is a light source, there is a linear relationship between the number of illuminated LEDs and the corresponding perceived light level. The flexible area 44 may optionally include a light transmissive area through which LED array 54 is visible.

Typical touch-operated devices 30 do not provide auditory or tactile feedback, such as is provided by the control switch actuator 18 of the prior art dimmer 10. When a user actuates the operational area, e.g., the flexible area 44 of the touch dimmer 40, it is desirable to provide some sort of sensory feedback to the user to inform the user that the dimmer 40 has received the input. Some prior art touch dimmers have provided visual feedback, e.g., the LED array 54, and auditory feedback via a speaker. However, prior art touch dimmers have suffered from not being able to provide an acceptable amount of sensory feedback to the user. Therefore, there is a need for a touch dimmer that provides an improved sensory feedback to a user in response an actuation of the operational area.

### SUMMARY OF THE INVENTION

According to an embodiment of the present invention, a load control device, which is connectable between a power source and the load, comprises a controllably conductive circuit for controlling the power supplied to the load from the power source between maximum and minimum values, a control structure operatively coupled to the controllably conductive circuit for adjusting the power applied to the load at any desired value between and including the maximum and minimum values, and a non-visual sensory output structure electronically coupled to the control structure for producing a variable human detectable output related to the adjustment of the control structure to indicate at least the direction of the change in power to the load during a change in the power applied to the load due to an adjustment of the control structure.

According to another embodiment of the present invention, a load control device for controlling the amount of power delivered from an AC power source to an electrical load comprises a controllably conductive device, a controller, and an audible sound generator. The controllably conductive device is adapted to be coupled in series electrical connection between the AC power source and the electrical load for controlling the amount of power delivered to the load. The controller is coupled to a control input of the controllably conductive device and is operable to selectively render the controllably conductive device conductive and non-conductive to control the amount of power delivered to the load. The audible sound generator is responsive to the controller to generate an audible sound having an operational characteristic, where the operational characteristic of the audible sound is controlled in response to the amount of power being delivered to the load.

According to another embodiment of the present invention, a lamp dimmer system for controlling the power delivered to a lamp comprises an adjustment control movable between first and second positions to vary the power applied to the lamp between respective first and second conditions, and a non-visual haptic output to announce the adjustment state of the lamp and to indicate at least the direction of the change in power to the load in response to the adjustment control.

The present invention further provides a method of providing feedback of the amount of power delivered from an AC power source to an electrical load. The method comprising the steps of adjusting the amount of power being delivered to the load, generating an audible sound having an operational characteristic, and controlling the operational characteristic of the audible sound in response to the amount of power being delivered to the load.

In addition, a process for operating a lamp dimming system comprises the steps of: (1) adjusting the power applied to a lamp; (2) producing an audio output signal containing at least one of a variable volume or variable frequency; and (3) adjusting at least one of said variable volume or variable frequency in accordance with the step of adjusting of the power applied to a lamp, such that said variable volume or variable frequency is related to the instantaneous power applied to said lamp, whereby increasing and decreasing the power applied to said lamp is respectively accompanied by one of an increasing or decreasing audio volume or audio frequency signal.

Other features and advantages of the present invention will become apparent from the following description of the invention that refers to the accompanying drawings.

### BRIEF DESCRIPTION OF THE DRAWINGS

FIG. 1 is a front view of a user interface of a prior art dimmer;

FIG. 2 is a cross-sectional view of a prior art touch-operated device;

FIG. 3 is a perspective view of a user interface of a prior art touch dimmer;

FIG. 4A is a perspective view of a touch dimmer according to a first embodiment of the present invention;

FIG. 4B is a front view of the touch dimmer of FIG. 4A;

FIG. 5A is a partial assembled sectional view of a bezel and the touch sensitive device of the touch dimmer of FIG. 4A;

FIG. 5B is a partial exploded sectional view of the bezel and the touch sensitive device of FIG. 5A;

FIG. 6 shows the force profiles of the components and a cumulative force profile of the touch dimmer of FIG. 4A;

FIG. 7 is a simplified block diagram of the touch dimmer of FIG. 4A;

FIG. 8 is a simplified schematic diagram of a stabilizing circuit and a usage detection circuit of the touch dimmer of FIG. 7;

FIGS. 9A and 9B are simplified schematic diagrams of the audible sound generator of the touch dimmer of FIG. 7;

FIG. 10A is a plot of the amplitude of the audible sounds generated by the audible sound generator as a function of the lighting intensity L of the lighting load;

FIG. 10B is a plot of the frequency of the audible sounds generated by the audible sound generator as a function of the lighting intensity L of the lighting load;

FIG. 11A is a plot of a waveform of a turn-on audible sound generated by an audible sound generator of the touch dimmer of FIG. 7 in which an amplitude of the turn-on audible sound increases with respect to time;

FIG. 11B is a plot of the amplitude of the turn-on audible sound waveform of FIG. 11A;

FIG. 11C is a plot of a frequency of the turn-on audible sound waveform of FIG. 11A;

FIG. 11D is a plot of a waveform of a turn-off audible sound generated by the audible sound generator of the touch dimmer of FIG. 7 in which an amplitude of the turn-off audible sound decreases with respect to time;

FIG. 11E is a plot of the amplitude of the turn-off audible sound waveform of FIG. 11D;

FIG. 11F is a plot of a frequency of the turn-off audible sound waveform of FIG. 11D;

FIG. 12A is a plot of a waveform of a high-end audible sound generated by the audible sound generator of the touch dimmer of FIG. 7;

FIG. 12B is a plot of an amplitude of the high-end audible sound waveform of FIG. 12A;

FIG. 12C is a plot of a frequency of the high-end audible sound waveform of FIG. 12A;

FIG. 12D is a plot of a waveform of a turn-on audible sound generated by the audible sound generator of the touch dimmer of FIG. 7 when the turn-on audible sound comprises a number of consecutive discrete sounds;

FIG. 12E is a plot of a waveform of a turn-off audible sound generated by the audible sound generator of the touch dimmer of FIG. 7 when the turn-off audible sound comprises a number of consecutive discrete sounds;

FIG. 12F is a plot of a waveform of a high-end audible sound generated by the audible sound generator of the touch dimmer of FIG. 7 when the high-end audible sound comprises a number of consecutive discrete sounds;

FIG. 13A is a plot of a waveform of a turn-on audible sound generated by the audible sound generator of the touch dimmer of FIG. 7 in which a frequency of the turn-on audible sound increases with respect to time;

FIG. 13B is a plot of an amplitude of the turn-on audible sound waveform of FIG. 13A;

FIG. 13C is a plot of the frequency of the turn-on audible sound waveform of FIG. 13A;

FIG. 13D is a plot of a waveform of a turn-off audible sound generated by the audible sound generator of the touch dimmer of FIG. 7 in which a frequency of the turn-off audible sound decreases with respect to time;

FIG. 13E is a plot of an amplitude of the turn-off audible sound waveform of FIG. 13D;

FIG. 13F is a plot of the frequency of the turn-off audible sound waveform of FIG. 13D;

FIG. 14A is a plot of a waveform of a turn-on audible sound generated by the audible sound generator of the touch dimmer of FIG. 7 in which the turn-on audible sound comprises a “click” sound;

FIG. 14B is a plot of a waveform of a turn-off audible sound generated by the audible sound generator of the touch dimmer of FIG. 7 in which the turn-off audible sound comprises a “dong” sound;

FIG. 14C is a plot of a waveform of a high-end audible sound generated by the audible sound generator of the touch dimmer of FIG. 7 in which the high-end audible sound comprises a “strum” sound;

FIG. 15 is a flowchart of a touch dimmer procedure executed by a controller of the dimmer of FIG. 4A;

FIG. 16 is a flowchart of an Idle procedure of the touch dimmer procedure of FIG. 15;

FIGS. 17A and 17B are flowcharts of an ActiveHold procedure of the touch dimmer procedure of FIG. 15;

FIG. 18 is a flowchart of a Release procedure of the touch dimmer procedure of FIG. 15;

FIG. 19 is a perspective view of a touch dimmer according to a further embodiment of the present invention;

FIG. 20 is a front view of the touch dimmer of FIG. 19;

FIG. 21 is a bottom cross-sectional view of the touch dimmer of FIG. 20;

FIG. 22 is an enlarged partial view of the bottom cross-sectional view of FIG. 21;

FIG. 23 is a left side cross-sectional view of the touch dimmer of FIG. 20;

FIG. 24 is an enlarged partial view of the left side cross-sectional view FIG. 23;

FIG. 25 is a perspective view of a display printed circuit board of the dimmer of FIG. 19;

FIG. 26A is a perspective view of a lamp control module having a rotary knob according to a further embodiment of the present invention;

FIG. 26B is a front view of the lamp control module of FIG. 26A;

FIG. 27 is a simplified block diagram of the lamp control module of FIGS. 26A and 26B;

FIG. 28A is a simplified diagram of first and second encoder control signals when the rotary knob of the lamp control module of FIG. 26A is being turned clockwise;

FIG. 28B is a simplified diagram of the first and second encoder control signals when the rotary knob of the lamp control module of FIG. 26A is being turned counter-clockwise;

FIG. 29 is a simplified flowchart of a rotary knob press procedure executed by a controller of the lamp control module of FIG. 26A;

FIG. 30 is a simplified flowchart of a count procedure executed by the controller of the lamp control module of FIG. 26A;

FIG. 31 is a simplified flowchart of an intensity adjustment procedure executed by the controller of the lamp control module of FIG. 26A; and

FIG. 32 is a simplified flowchart of the intensity acceleration routine executed by the controller of the lamp control module of FIG. 26A.

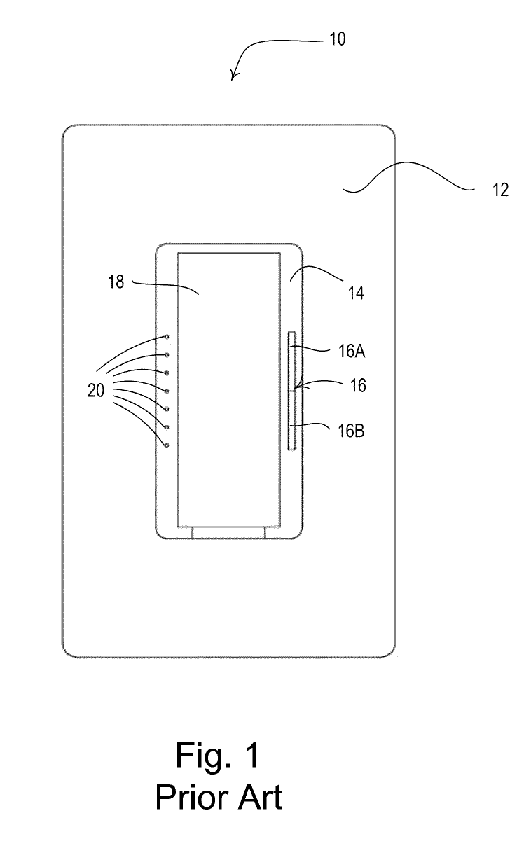

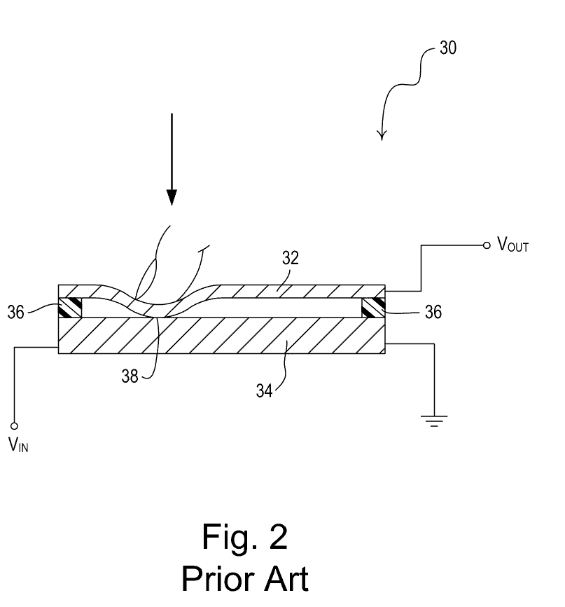

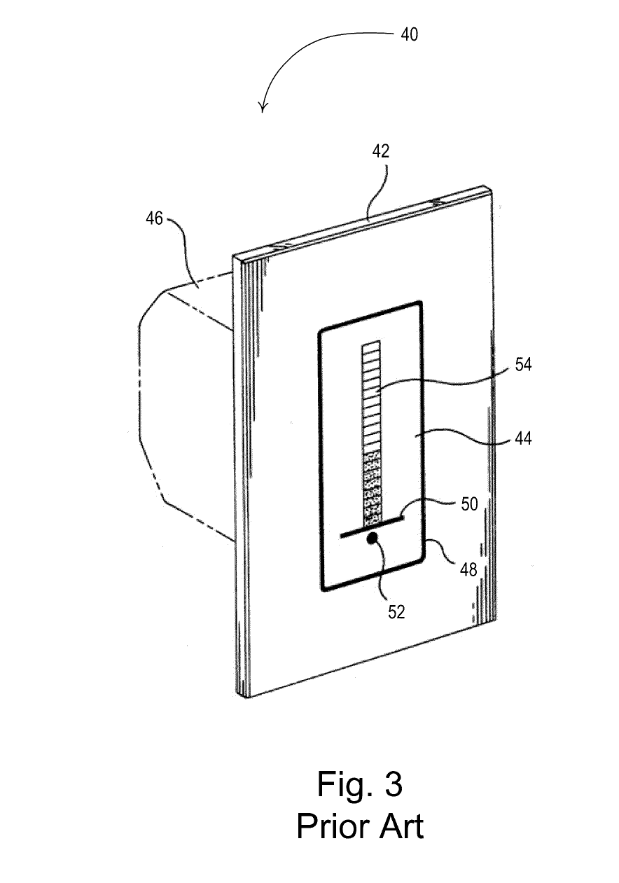

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

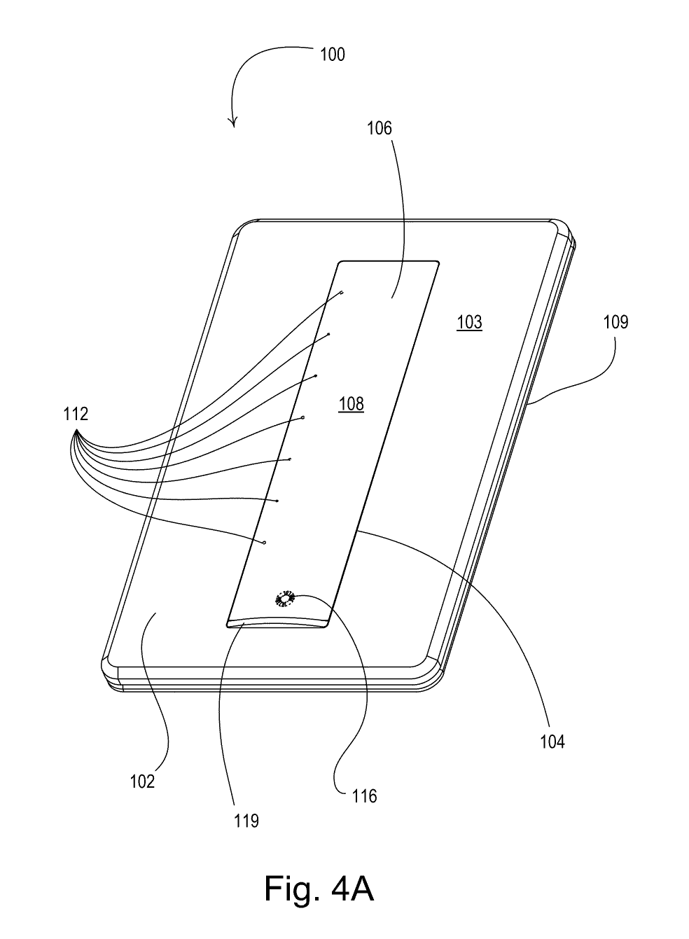

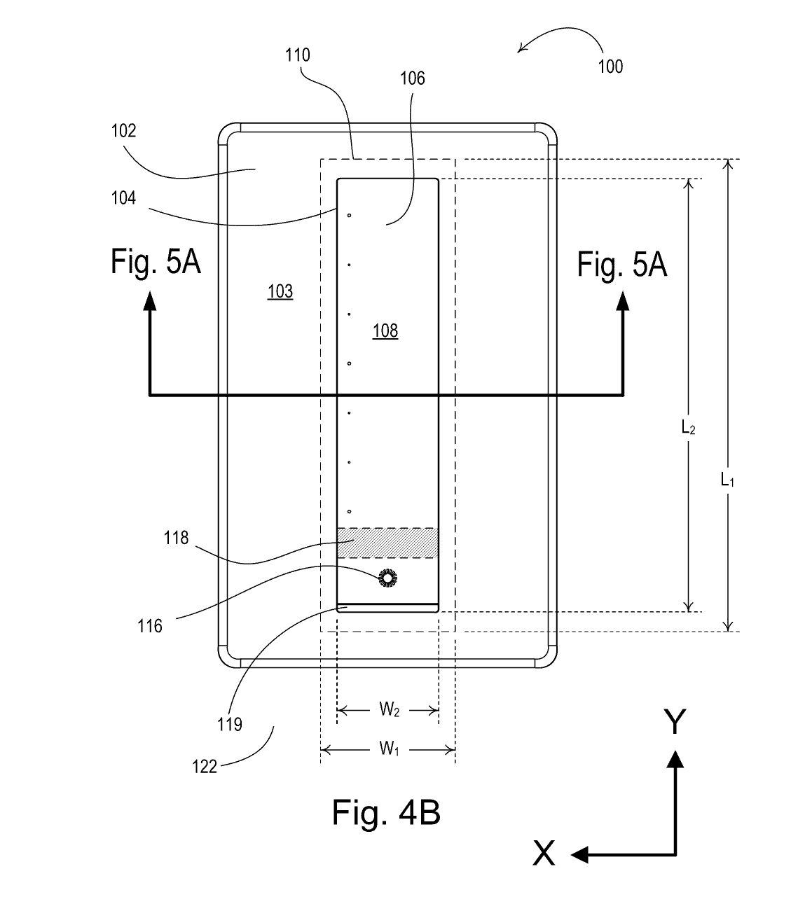

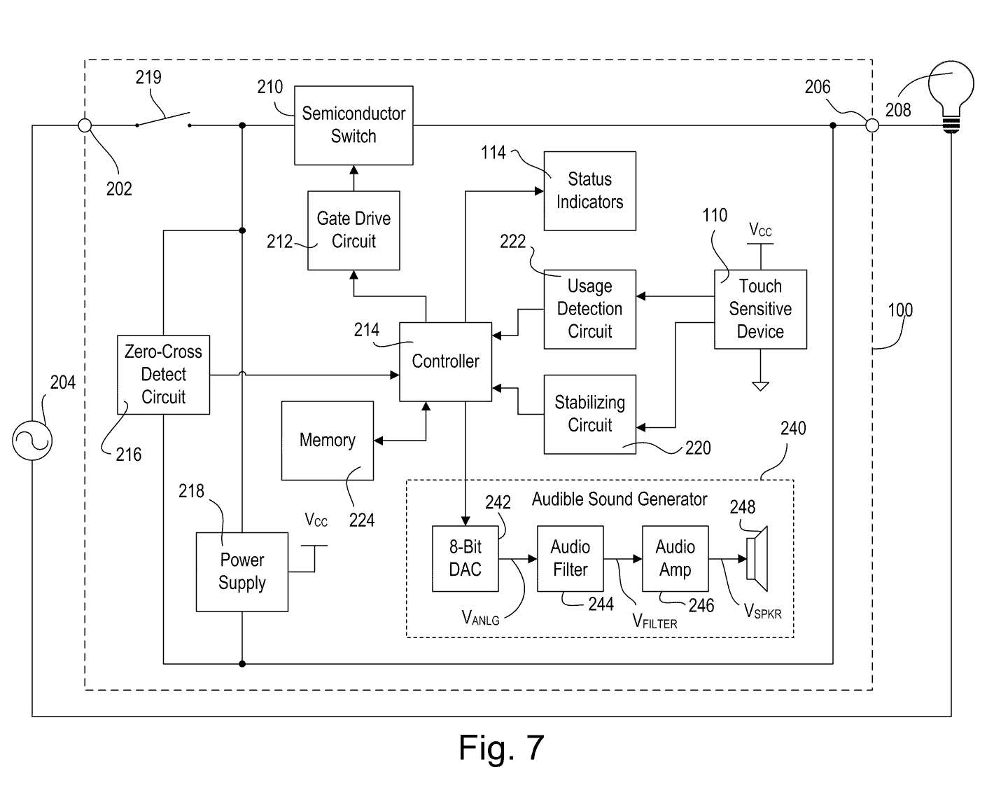

FIGS. 4A and 4B are a perspective view and a front view, respectively, of a touch dimmer 100 according to a first embodiment of the present invention. The dimmer 100 is operable to be connected between an AC voltage source 204 (FIG. 7) and a lighting load 208 (FIG. 7) for turning the lighting load on and off The dimmer 100 is also operable to control the amount of power delivered to the lighting load any desired value between and including maximum and minimum values. As a result, the dimmer 100 is able to control an intensity L of the lighting load between a minimum (i.e., low-end) intensity L_{MIN} (e.g., 1%) and a maximum (i.e., high-end) intensity L_{MAX} (e.g., 100%). The dimmer 100 includes a faceplate 102, i.e., a cover plate, having a planar front surface 103 and an opening 104. The opening 104 may define a standard industry-defined opening, such as a traditional opening or a decorator opening, or another uniquely-sized opening as shown in FIG. 4A.

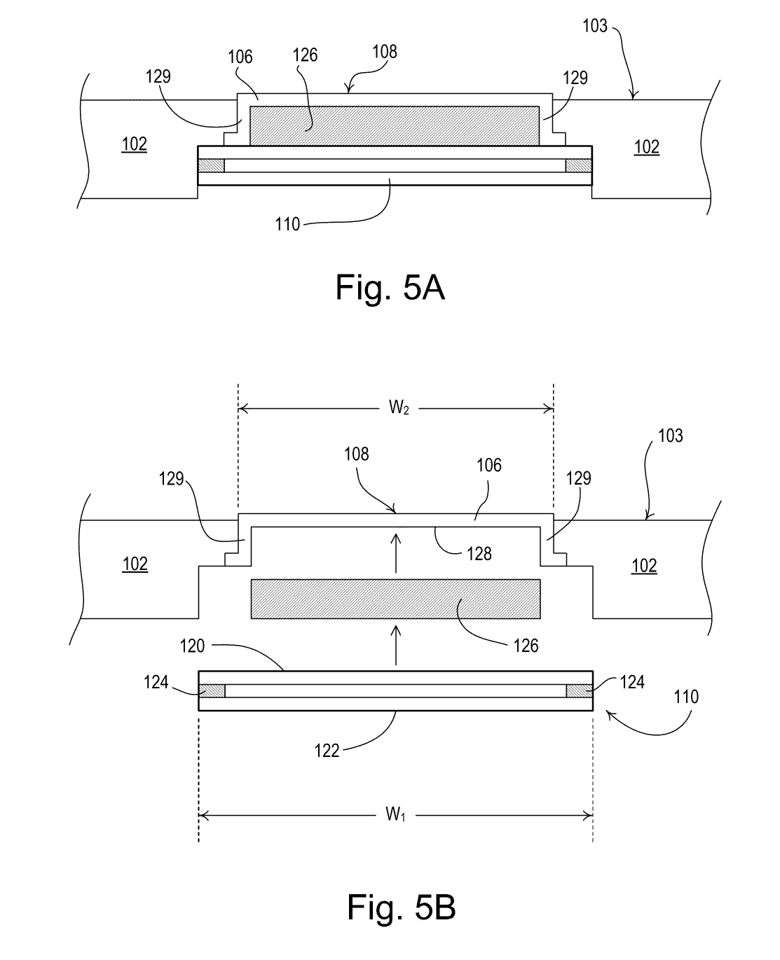

The dimmer 100 comprises a control structure that allows for adjusting the power applied to the lighting load and thus to control the lighting intensity L between the minimum intensity L_{MIN} and the maximum intensity L_{MAX}. Specifically, the dimmer 100 comprises a bezel 106 having a planar touch sensitive front surface 108 that extends through the opening 104 of the faceplate 102. The front surface 108 of the bezel 106 is positioned immediately above a touch sensitive device 110 (shown in FIGS. 5A and 5B), i.e., a touch sensitive element, such that a user of the dimmer 100 actuates the touch sensitive element 110 by pressing the front surface 108 of the bezel 106. As shown in FIG. 4A and FIG. 5A, the front surface 108 of the bezel 106 is substantially flush with the front surface 103 of the faceplate 102, i.e., the plane of the front surface 108 of the bezel 106 is coplanar with the plane of the front surface 103 of the faceplate 102. However, the bezel 106 may extend through the opening 104 of the faceplate 102 such that the front surface 108 of the bezel is provided in a plane slightly above the plane of the front surface 103 of the faceplate 102. The faceplate 102 is connected to an adapter 109 (FIG. 4A), which is connected to a yoke (not shown). The yoke is adapted to mount the dimmer 100 to a standard electrical wallbox.

The dimmer 100 further comprises a visual display, e.g., a plurality of status markers 112 provided in a linear array along an edge of the front surface 108 of the bezel 106. The status markers 112 are illuminated from behind by status indicators 114, e.g., light-emitting diodes (LEDs), located internal to the dimmer 100 (as will be described in greater detail below with reference to FIG. 7). The dimmer 100 comprises a light pipe (not shown) having a plurality of light conductors to conduct the light from the status indicators 114 inside the dimmer to the markers 112 on the front surface 108 of the bezel 106. The status indicators 114 behind the markers 112 may be, for example, blue. The dimmer 100 may comprise, for example, seven (7) status markers 112 as shown in FIGS. 4A and 4B. However, the dimmer 100 may comprise any number of status markers. Further, the status markers 112 may be disposed in a vertical linear array along the center of the front surface 108 of the bezel 106. The markers 112 may comprise shadows apparent on the front surface 108 due to voids behind the front surface.

The front surface 108 of the bezel 106 further includes an icon 116. The icon 116 may be any sort of visual marker, such as, for example, a dot. Upon actuation of the lower portion of the front surface 108 surrounding the icon 116, the dimmer 100 causes the connected lighting load 208 to change from on to off (and vice versa), i.e., to toggle. When the lighting load 208 is turned on in response to a press of the lower portion of the front surface 108 surrounding the icon 116, the dimmer 100 may turn the lighting load on to a preset lighting intensity L_{PRESET} (e.g., the lighting intensity L of the lighting load before the lighting load was last turned off). Two status indicators, for example, a blue status indicator and an orange status indicator, may be located immediately behind the icon 116, such that the icon 116 is illuminated with blue light when the lighting load 208 is on and illuminated with orange light when the lighting load is off. Actuation of the upper portion of the front surface 108, i.e., above the portion surrounding the icon 116, causes the lighting intensity L of the lighting load 208 to change. In other words, the upper portion of the front surface 108 operates as an intensity adjustment control (or actuator). The status indicators 114 behind the status markers 112 are illuminated to display a representation of the lighting intensity L of the lighting load 208. For example, if the lighting load 208 is at 50% lighting intensity, the middle status indicator will be illuminated. The dimmer 100 does not respond to actuations in a keepout region 118 of the front surface 108. The keepout region 118 prevents inadvertent actuation of an undesired portion of the front surface 108 during operation of the dimmer 100.

The dimmer 100 further comprises a non-visual sensory (i.e., haptic) output structure for producing a variable human detectable output that announces an adjustment of the state of the lighting load 208. The variable human detectable output may be related to in an adjustment of the amount of power being delivered to the lighting load 208 to indicate at least the direction of the change in power to the load. For example, the non-visual sensory output structure may comprise an internal audible sound generator 240 (FIG. 7) for producing audible sounds in response to actuations of the touch sensitive device 110.

The dimmer 100 further includes an airgap switch actuator 119. Pulling the airgap switch actuator 119 opens a mechanical airgap switch 219 (FIG. 7) inside the dimmer 100 and disconnects the lighting load 208 from the AC voltage source 204. The airgap switch actuator 119 extends only sufficiently above the front surface 103 of the faceplate 102 to be gripped by a fingernail of a user. The electronic circuitry of the dimmer 100 (to be described in greater detail below) is mounted on a printed circuit board (PCB) (not shown). The PCB is housed in an enclosure (not shown), i.e., an enclosed volume, which is attached to the yoke of the dimmer 100.

FIG. 5A is a partial assembled sectional view and FIG. 5B is a partial exploded sectional view of the bezel 108 and the touch sensitive device 110 of the dimmer 100 according to the first embodiment of the present invention. The touch sensitive device 110 comprises, for example, a resistive divider, and operates in a similar fashion as the touch-operated device 30 of the prior art touch dimmer 40. The touch sensitive device 110 includes a conductive element 120 and a resistive element 122 supported by a spacing frame 124. However, the touch sensitive device 110 may comprise a capacitive touch screen or any other type of touch responsive element. Such touch sensitive devices are often referred to as touch pads or touch screens.

An elastomer 126 is received by an opening 128 in the rear surface of the bezel 106. The elastomer 126 is positioned between the bezel 106 and the touch sensitive device 110, such that a press on the front surface 108 of the bezel is transmitted to the conductive element 120 of the touch sensitive device 110. For example, the elastomer 126 may be made of rubber and may be approximately 0.040″ thick. The elastomer 126 has, for example, a durometer of 40 A, but may have a durometer in the range of 20 A to 80 A. The conductive element 120 and the resistive element 122 of the touch sensitive device 110 and the elastomer 126 are manufactured from a transparent material such that the light from the plurality of status indicators 114 inside the dimmer 100 are operable to shine through the touch sensitive device 110 and the elastomer 126 to front surface 108 of the bezel 106.

The position and size of the touch sensitive device 110 is demonstrated by the dotted line in FIG. 4B. The touch sensitive device 110 has a length L₁ and a width W₁ that is larger than a length L₂ and a width W₂ of the front surface 108 of the bezel 106. Accordingly, a first area A₁ of the surface of touch sensitive device 110 (i.e., A₁=L₁·W₁) is greater than a second area A₂ of the front surface 108 of the bezel 106 (i.e., A₂=L₂·W₂). An orthogonal projection of the second area A₂ onto the first area A₁ is encompassed by the first area A₁, such that a point actuation at any point on the front surface 108 of the bezel 106 is transmitted to the conductive element 120 of the touch sensitive device 110. As shown in FIGS. 4A and 4B, the length L₂ of the front surface 108 of the bezel 106 is approximately four (4) times greater than the width W₂. For example, the length L₂ of the front surface 108 of the bezel 106 may be four (4) to six (6) times greater than the width W₂. Alternatively, the front surface 108 of the bezel 106 may be provided in an opening of a decorator-style faceplate

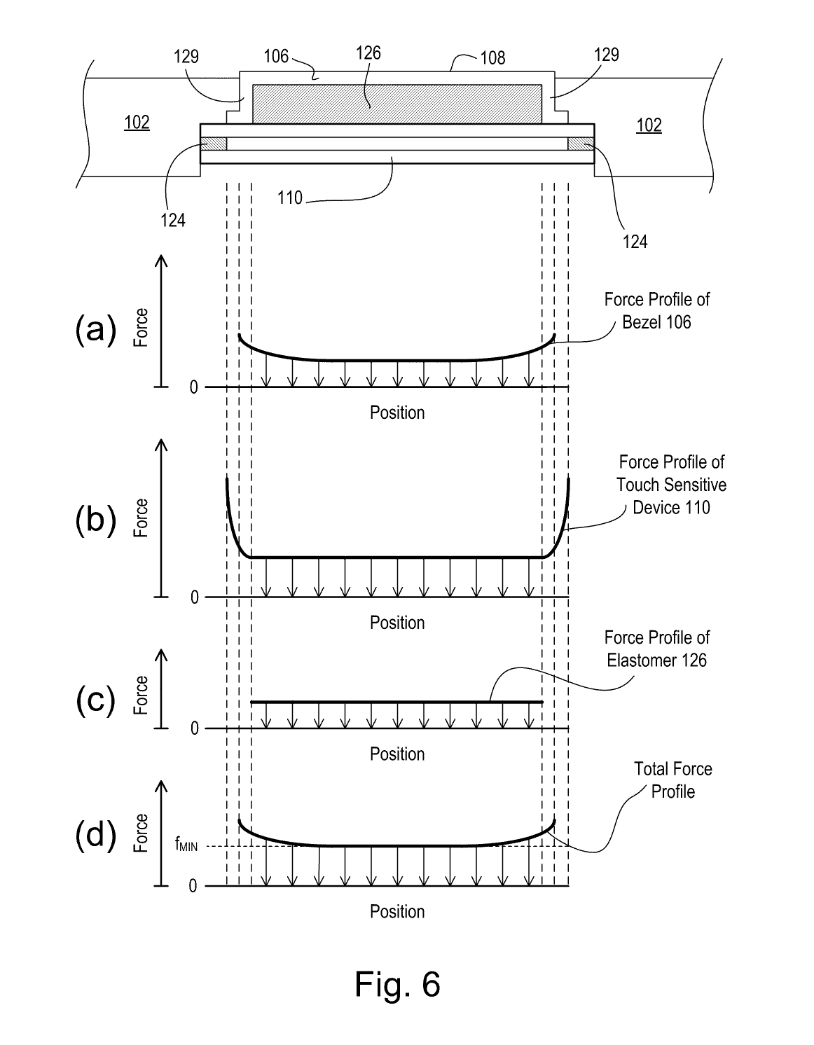

FIG. 6 shows the force profiles of the components of the dimmer 100 shown in FIGS. 5A and 5B and a cumulative force profile for the touch sensitive device 110 of the dimmer 100. Each of the force profiles shows the force required to actuate the touch sensitive device 110 with respect to the position of the point actuation. The force profile represents the amount of force required to displace the element by a given amount. While the force profiles in FIG. 6 are shown with respect to the widths of the components of the dimmer 100, a similar force profile is also provided along the length of the components.

FIG. 6(a) shows a force profile of the bezel 106. The bezel 106 has substantially thin sidewalls 129, e.g., approximately 0.010″ thick, such that the bezel 106 exhibits a substantially flat force profile. FIG. 6(b) shows a force profile of the touch sensitive device 110. The force required to actuate the touch sensitive device 110 increases near the edges because of the spacing frames 124. FIG. 6(c) shows a force profile of the elastomer 126. The force profile of the elastomer 126 is substantially flat, i.e., a force at any point on the front surface of the elastomer 126 will result in a substantially equal force at the corresponding point on the rear surface.

FIG. 6(d) is a total force profile of the touch dimmer 100. The individual force profiles shown in FIGS. 6(a)-6(c) are additive to create the total force profile. The total force profile is substantially flat across the second area A₂ of the front surface 108 of the bezel 106. This means that a substantially equal minimum actuation force f_{MIN} is required to actuate the touch sensitive device 110 at all points of the front surface 108 of the bezel 106, even around the edges. Accordingly, the dimmer 100 provides a maximum operational area in an opening of a faceplate, i.e., substantially all of the second area A₂ of the front surface 108 of the bezel 106, which is an improvement over the prior art touch dimmers. The minimum actuation force f_{MIN} is substantially equal at all points on the front surface 108 of the bezel 106. For example, the minimum actuation force f_{MIN} may be approximately 20 grams.

FIG. 7 is a simplified block diagram of the touch dimmer 100 according to the first embodiment of the present invention. The dimmer 100 has a hot terminal 202 connected to an AC voltage source 204 and a dimmed hot terminal 206 connected to a lighting load 208. The dimmer 100 employs a controllably conductive circuit, such as, for example, a bidirectional semiconductor switch 210, coupled between the hot terminal 202 and the dimmed hot terminal 206, to control the current through, and thus the lighting intensity L of, the lighting load 208. The bidirectional semiconductor switch 210 may comprise any suitable type of controllably conductive device, such as, for example, a triac, a field-effect transistor (FET) in a rectifier bridge, or two FETs in anti-series connection. The semiconductor switch 210 has a control input (or gate), which is connected to a gate drive circuit 212. The input to the gate renders the semiconductor switch 210 selectively conductive or non-conductive, which in turn controls the power supplied to the lighting load 208. The gate drive circuit 212 provides a control input to the semiconductor switch 210 in response to a control signal from a controller 214. The controller 214 may be any suitable controller, such as a microcontroller, a microprocessor, a programmable logic device (PLD), or an application specific integrated circuit (ASIC).

A zero-crossing detect circuit 216 determines the zero-crossing points of the AC source voltage from the AC power supply 204. A zero-crossing is defined as the time at which the AC supply voltage transitions from positive to negative polarity, or from negative to positive polarity, at the beginning of each half-cycle. The zero-crossing information is provided as an input to the controller 214. The controller 214 generates the gate control signals to operate the semiconductor switch 210 to thus provide voltage from the AC power supply 204 to the lighting load 208 at predetermined times relative to the zero-crossing points of the AC waveform. A power supply 218 generates a direct-current (DC) voltage V_{CC}, e.g., 5 volts, to power the controller 214 and other low voltage circuitry of the dimmer 100.

The touch sensitive device 110 is coupled to the controller 214 through a stabilizing circuit 220 and a usage detection circuit 222. The stabilizing circuit 220 is operable to stabilize the voltage output of the touch sensitive device 110. Accordingly, the voltage output of the stabilizing circuit 220 is not dependent on the magnitude of the force of the point actuation on the touch sensitive device 110, but rather is dependent solely on the position of the point actuation. The usage detection circuit 222 is operable to detect when a user is actuating the front surface 108 of the dimmer 100. The controller 214 is operable to control the operation of the stabilizing circuit 220 and the usage detection circuit 222 and to receive control signals from both the stabilizing circuit and the usage detection circuit. The stabilizing circuit 220 has a slow response time, while the usage detection circuit 222 has a fast response time. Thus, the controller 214 is operable to control the semiconductor switch 210 in response to the control signal provided by the stabilizing circuit 220 when the usage detection circuit 222 has detected an actuation of the touch sensitive device 110.

The controller 214 is operable to drive the plurality of status indicators 114, e.g., light-emitting diodes (LEDs), which are located behind the markers 112 on the front surface 108 of the dimmer 100. The status indicators 114 also comprise the blue status indicator and the orange status indicator that are located immediately behind the icon 116. The blue status indicator and the orange status indicator may be implemented as separate blue and orange LEDs, respectively, or as a single bi-colored LED. A memory 224 is coupled to the controller 214 and is operable to store control information of the dimmer 100.

The dimmer 100 further comprises an audible sound generator 240 coupled to the controller 214 for producing audible sounds in response to actuations of the touch sensitive device 110. The audible sound generator 240 comprises a digital-to-analog converter (DAC) 242 (e.g., an 8-bit DAC) for converting a plurality of digital signals provided by the controller 214 into an analog audio signal V_{ANLG}. The analog sound signal V_{ANLG} is filtered by an audio filter 244 to produce a filtered analog audio signal V_{FILTER}, which is amplified by an audio amplifier (“amp”) 246 to generate a speaker audio signal V_{SPKR}. The speaker sound signal V_{SPKR} is coupled to a speaker 248 (e.g., a piezoelectric or magnetic speaker) for generating the audible sounds.

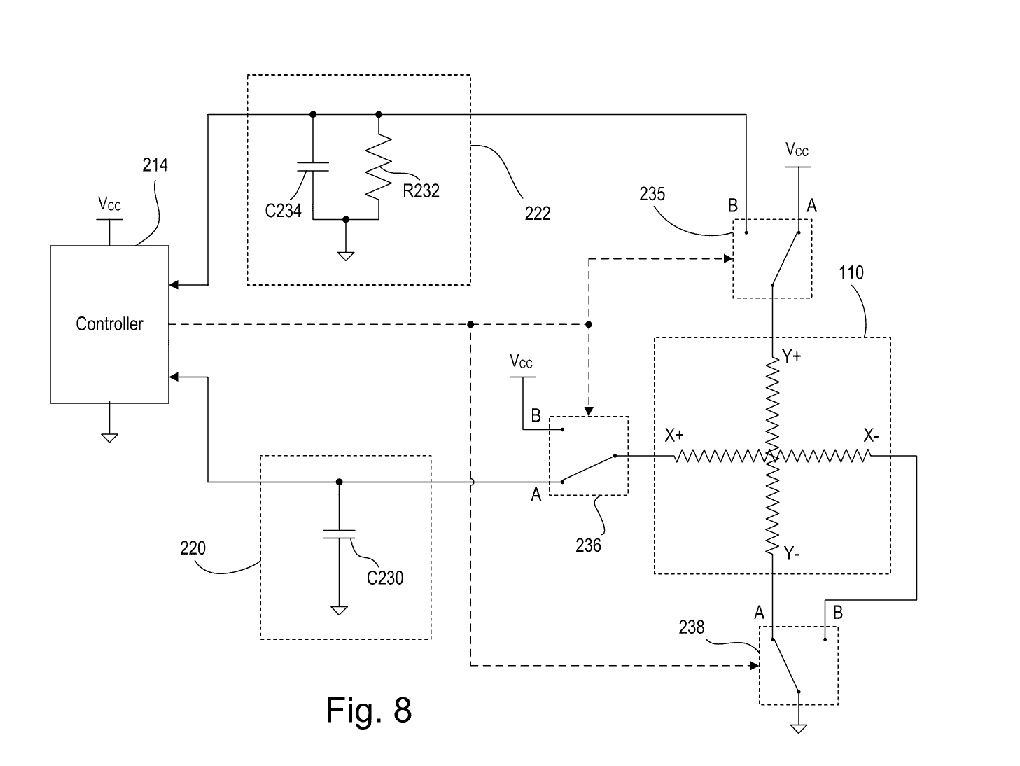

FIG. 8 is a simplified schematic diagram of the circuitry electrically coupled between the touch sensitive device 110 and the controller 214, i.e., the stabilizing circuit 220 and the usage detection circuit 222, according to the first embodiment of the present invention. As shown in FIG. 8, the touch sensitive device 110 comprises a four-wire touch sensitive device. The touch sensitive device 110 comprises two resistive elements (i.e., an X-axis resistive element and a Y-axis resistive element), each having, for example, a resistance of approximately 7.6 kΩ. Accordingly, the touch sensitive device 110 has four connections (i.e., electrodes) and provides two outputs. A first output (i.e., the X+ terminal) is representative of the position of a point actuation along the Y-axis resistive element (i.e., along the longitudinal axis of the dimmer 100 as shown in FIG. 4B). A second output (i.e., the Y+ terminal) is representative of the position of the point actuation along the X-axis resistive element (i.e., along an axis perpendicular to the longitudinal axis). The stabilizing circuit 220 is operatively coupled to the X+ terminal and the usage detection circuit 222 is operatively coupled to the Y+ terminal.

The controller 214 controls three switches 235, 236, 238 to selectively connect the DC voltage V_{CC} to the X-axis resistive element and the Y-axis resistive element of the touch sensitive device 110. The DC voltage V_{CC} thus provides a biasing voltage for either the X-axis resistive element or the Y-axis resistive element of the touch sensitive device 110 in response to the controller 214. The touch sensitive device 110 provides the outputs depending on how the DC voltage V_{CC} is connected to the touch sensitive device. When the switches 235, 236, 238 are connected in position A as shown in FIG. 8, the DC voltage V_{CC} is coupled across the Y-axis resistive element, and the X-axis resistive element provides the output to the stabilizing circuit 220. When the switches 235, 236, 238 are connected in position B, the DC voltage V_{CC} is coupled across the X-axis resistive element, and the Y-axis resistive element provides the output to the usage detection circuit 222.

When the DC voltage V_{CC} is coupled across the Y-axis resistive element (i.e., the switches 235, 236, 238 are in position A), the X+ terminal of the touch sensitive device 110 provides the output to the stabilizing circuit 220. The stabilizing circuit 220 comprises a whacking-grade capacitor C230 (that is, a capacitor having a large value of capacitance). When the capacitor C230 is coupled to the X+ terminal of the touch sensitive device 110, the output voltage is filtered by the capacitor C230. When a touch is present on the front surface 108 of the bezel 106, the voltage on the capacitor C230 will be forced to a steady-state voltage representing the position of the touch on the front surface. When no touch is present on the front surface 108 of the bezel 106, the voltage on the capacitor will remain at a voltage representing the position of the last touch. The touch sensitive device 110 and the capacitor C230 form a sample-and-hold circuit. The response time of the sample-and-hold circuit is determined by a resistance R_{D} of the touch sensitive device (i.e., the resistance R_{E} of the resistive element and a contact resistance R_{C}) and the capacitance C₂₃₀ of the capacitor C230. During a typical actuation, the contact resistance R_{C} is small compared to the value of the resistance R_{E} of the resistive element, such that a first charging time constant τ₁ is approximately equal to R_{E} ·C₂₃₀. This time constant τ₁ is, for example, approximately 13 ms, but may be anywhere between approximately 6 msec and 15 msec.

When a light or transient press is applied to the front surface 108 of the bezel 106 (and thus the touch sensitive device 110), the capacitor C230 will continue to hold the output at the voltage representing the position of the last touch. During the release of the front surface 108 of the bezel 106 (and the touch sensitive device 110), transient events may occur that produce output voltages that represent positions other than the actual touch position. Transient presses that are shorter than the first charging time constant τ₁ will not substantially affect the voltage on the capacitor C230, and therefore will not substantially affect the sensing of the position of the last actuation. During a light press, a second charging time constant τ₂ will be substantially longer than during normal presses, i.e., substantially larger than the first time constant τ₁, due to the higher contact resistance R_{C}. However, the steady-state value of the voltage across the capacitor C230 will be the same as for a normal press at the same position. Therefore, the output of the stabilizing circuit 220 is representative of only the position of the point of actuation on the front surface 108 of the bezel 106 (and the touch sensitive device 110).

When the switches 235, 236, 238 are connected in position B, the DC voltage V_{CC} is coupled across the X-axis resistive element, and the Y+ terminal of the touch sensitive device 110 provides the output to the usage detection circuit 222. The usage detection circuit 222 comprises a resistor R232 and a capacitor C234. When the switches 235, 236, 238 are connected in position B, the parallel combination of the resistor R232 and the capacitor C234 is coupled to the Y+ terminal of the touch sensitive device 110. For example, the capacitor C234 has a substantially small capacitance C₂₃₄, such that the capacitor C234 charges substantially quickly in response to all point actuations on the front surface 108. The resistor R232 allows the capacitor C234 to discharge quickly when the switch 238 is non-conductive. Therefore, the output of the usage detection circuit 222 is representative of the instantaneous usage of the touch sensitive device 110.

The controller 214 controls the switches 235, 236, 238 to be in position B for a short period of time t_{USAGE}, for example, once every half cycle of the voltage source 204 to determine whether the user is actuating the front surface 108. The short period of time t_{USAGE} is, for example, approximately 100 μsec or 1% of the half-cycle (assuming each half-cycle is approximately 8.33 msec long). For the remainder of the time, the switches 235, 236, 238 are in position A, such that the capacitor C230 is operable to charge accordingly. When the switches 235, 236, 238 are in position B, the whacking-grade capacitor C230 of the stabilizing circuit 220 is unable to discharge at a significant rate, and thus the voltage developed across the capacitor C230 will not change significantly when the controller 214 is determining whether the touch sensitive device 110 is being actuated through the usage detection circuit 222.

Alternatively, the touch sensitive device 110 could comprise a three-wire touch sensitive device. Alternative embodiments of the touch sensitive device 110, the stabilizing circuit 220, and the usage detection circuit 222 are shown and described in the parent application (i.e., U.S. patent application Ser. No. 11/472,245).

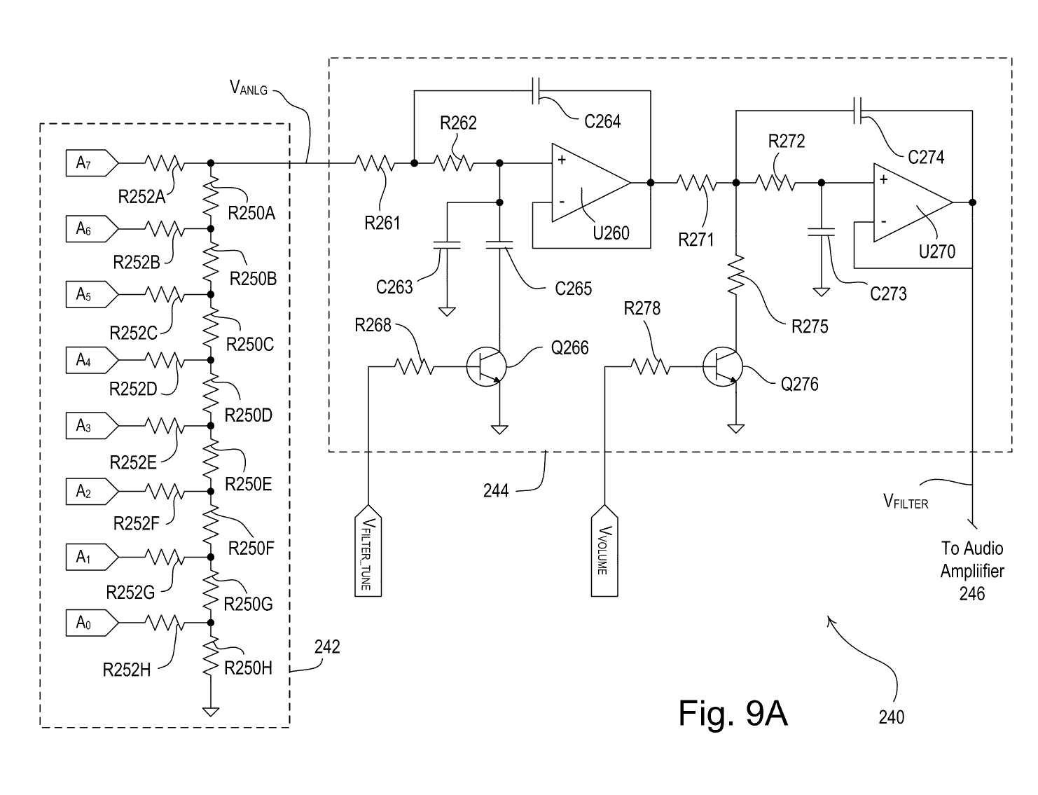

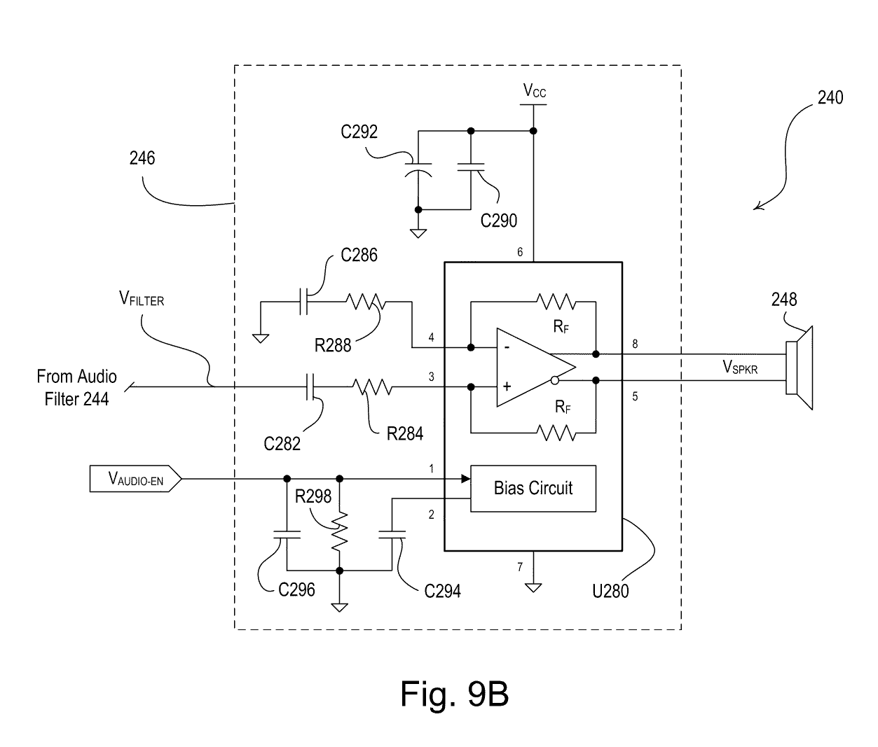

FIGS. 9A and 9B are simplified schematic diagrams of the audible sound generator 240 of the dimmer 100. As shown in FIG. 9A, the DAC 242 comprises an “R-2R” resistor ladder circuit. The DAC 242 receives a plurality of digital (i.e., binary) signals A₀-A₇ from the controller 214, where the signal A₀ represents the least significant bit. The DAC 242 comprises a plurality of resistors R250A-R250H, which each have, for example, a resistance of approximately 511Ω, and a plurality of resistors R252A-R252H, which each have, for example, a resistance of approximately 1.0 kΩ. The controller 214 generates the plurality of digital signals A₀-A₇ (i.e., to be a logic high level or a logic low level), such that the appropriate analog audio signal V_{ANLG} is produced at the output of the DAC 242. Alternatively, the DAC 242 could be implemented as a DAC integrated circuit (IC), such as, for example, part number DAC081 manufactured by National Semiconductor Corporation.

The analog sound signal V_{ANLG} is provided to the audio filter 244, which may comprise a two-stage Sallen Key filter that operates as a 2nd-order low pass filter. The first stage of the audio filter 244 comprises an operational amplifier (“op amp”) U260 (e.g., part number LM2904 manufactured by National Semiconductor). The analog sound signal V_{ANLG} is coupled to the non-inverting terminal of the op amp U260 via two resistors R261, R262 (e.g., having resistances of approximately 2 kΩ and 20 kΩ, respectively). The non-inverting terminal of the op amp U260 is also coupled to circuit common via a capacitor C263 (e.g., having a capacitance of approximately 680 pF). A capacitor C264 is coupled between the junction of the two resistors R261, R262 and the output terminal of the op amp U260, and has, for example, a capacitance of approximately 0.01 μF. The inverting terminal is coupled directly to the output terminal of the op amp U260.

The second stage of the audio filter 244 comprises another op amp U270. The non-inverting terminal of the op amp U270 is coupled to the output of the op amp U260 of the first stage via two resistors R271, R272 (e.g., having resistances of approximately 1 kΩ and 15 kΩ, respectively), and is coupled to circuit common via a capacitor C273 (e.g., having a capacitance of approximately 2200 pF). The output of the op amp U270 is coupled directly to the inverting terminal and coupled to the junction of the resistors R271, R272 via a capacitor C274 (e.g., having a capacitance of approximately 2200 pF). The output of the op amp U270 provides the filtered analog audio signal V_{FILTER} to the audio amp 246. The audio filter 244 operates to filter high-frequency noise from the analog audio signal V_{ANLG}.

The controller 214 is coupled to the first stage of the audio filter 244 for controlling the cutoff frequency of the filter. Specifically, a capacitor C265 is coupled to the non-inverting terminal of the comparator U260 and has a capacitance of, for example, approximately 2200 pF. An NPN bipolar junction transistor Q266 is coupled between the capacitor C265 and circuit common. The controller 214 provides a filter tuning control signal V_{FILTER} TUNE to the base of the transistor Q266 via a resistor R268 (e.g., having a resistance of approximately 1 kΩ). When the controller 214 renders the transistor Q266 conductive, the capacitor C265 is coupled in parallel with the capacitor C263 of the first stage of the audio filter 244, thus causing the cutoff frequency to increase, such that the audio filter 244 operates with higher frequency audio signals.

The controller 214 is also coupled to the second stage of the audio filter 244 for controlling the amplitude of the filtered analog audio signal V_{FILTER} provided to the audio amp 246 and thus the volume of the audible sound generated by the speaker 248. A resistor R275, which has a resistance of, for example, approximately 681Ω, is coupled between the junction of the two resistors R271, R272 and circuit common via an NPN bipolar junction transistor Q276. The controller 214 provides a volume control signal V_{VOLUME} to the base of the transistor Q276 via a resistor R278 (e.g., having a resistance of approximately 1 kΩ). When the controller 214 renders the transistor R276 conductive, the resistor R275 pulls the voltage at the junction of the resistors R271, R272 down towards circuit common, thus attenuating the filtered analog audio signal V_{FILTER} generated by the audio filter 244.

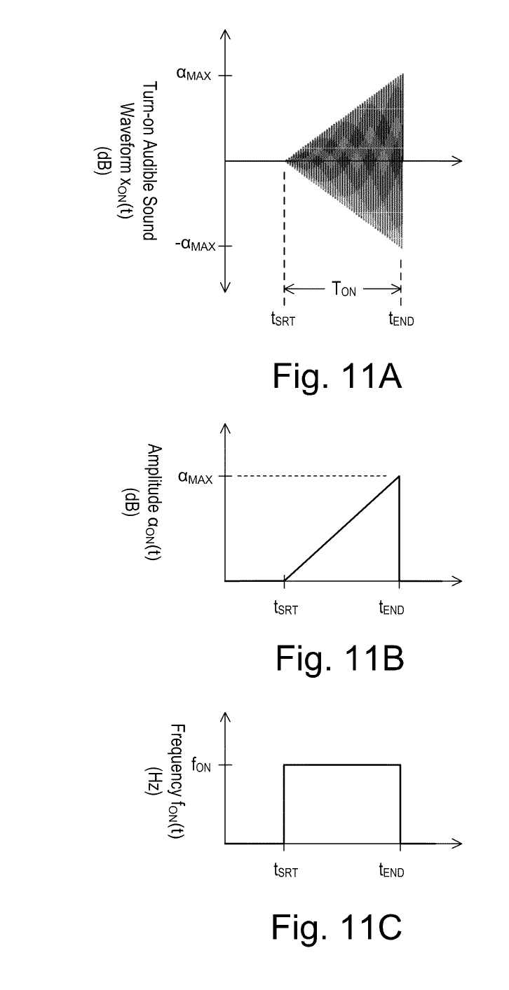

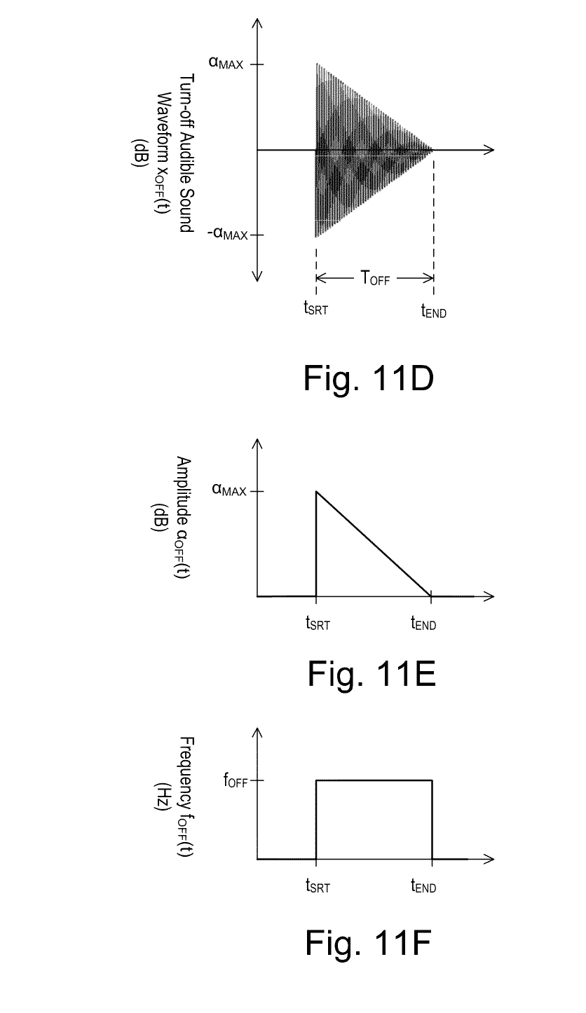

Referring to FIG. 9B, the audio amp 246 receives the filtered analog audio signal V_{FILTER} from the audio filter 244 and may comprise, for example, a differential audio power amplifier IC U280, such as part number TPA6204A1 manufactured by Texas Instruments Incorporated. The audio power amplifier IC U280 receives a differential audio signal at positive and negative input terminals (i.e., pins 3 and 4, respectively). The positive input terminal is coupled to the audio filter 244 via a capacitor C282 (e.g., having a capacitance of approximately 0.047 uF) and a resistor R284 (e.g., having a resistance of approximately 20 kΩ). The negative input terminal is coupled to circuit common via a capacitor C286 (e.g., having a capacitance of approximately 0.047 uF) and a resistor R288 (e.g., having a resistance of approximately 20 kΩ). The gain of the audio amp 246 is set by the resistance of the resistor R284 and one of two internal feedback resistors R_{F}. Each of the internal feedback resistors R_{F} has a resistance of approximately 40 kΩ, such that the gain is approximately two (2). The audio power amplifier IC U280 generates the speaker sound signal V_{SPKR} for the speaker 248 at differential output terminals (i.e., pins 5 and 8). For example, the speaker sound signal V_{SPKR} may comprise turn-on, turn-off, and high-end audible sound waveforms x_{ON}(t), x_{OFF}(t), x_{HE}(t), which are shown in FIGS. 11A-14C and will be described in greater detail below.

The audio power amplifier IC 280 is coupled to the DC voltage V_{CC} (pin 6) and circuit common (pin 7) to power the amplifier IC. The DC voltage V_{CC} is coupled to circuit common via a high-frequency noise-filtering capacitor C290 (e.g., having a capacitance of approximately 0.22 μF) and a charge storage capacitor C292, which filters lower frequency noise and has a capacitance of, for example, approximately 10 μF. The audio power amplifier IC U280 comprises an internal bias circuit for generating internal bias voltages. A capacitor C294 is coupled between the bias circuit (i.e., pin 2) and circuit common and has a capacitance of, for example, approximately 0.047 μF. The controller 214 is coupled to the audio amp 246 for enabling and disabling the audio amp. Specifically, the controller 214 provides an audio enable control signal V_{AUDIO-EN} to an enable terminal of the audio power amplifier IC U280 (i.e., pin 1). The enable terminal is coupled to circuit common via the parallel combination of a capacitor C296 (e.g., having a capacitance of approximately 0.01 μF) and a resistor R298 (e.g., having a resistance of approximately 100 kΩ). The audible sound generator 240 generates the audible sound when the audio enable control signal V_{AUDIO-EN} is at a logic high level.

According to the present invention, the controller 214 controls the audible sound generator 240, such that a variable operating or operational characteristic of the audible sounds generated by the audible sound generator (e.g., the amplitude or the frequency of the audible sound) is responsive to and representative of the amount of power presently being delivered to (i.e., the lighting intensity L of) the lighting load 208. For example, the variable operating or operational characteristic may be continuously functionally related to the increase or decrease of the amount of power being supplied to the lighting load 208.

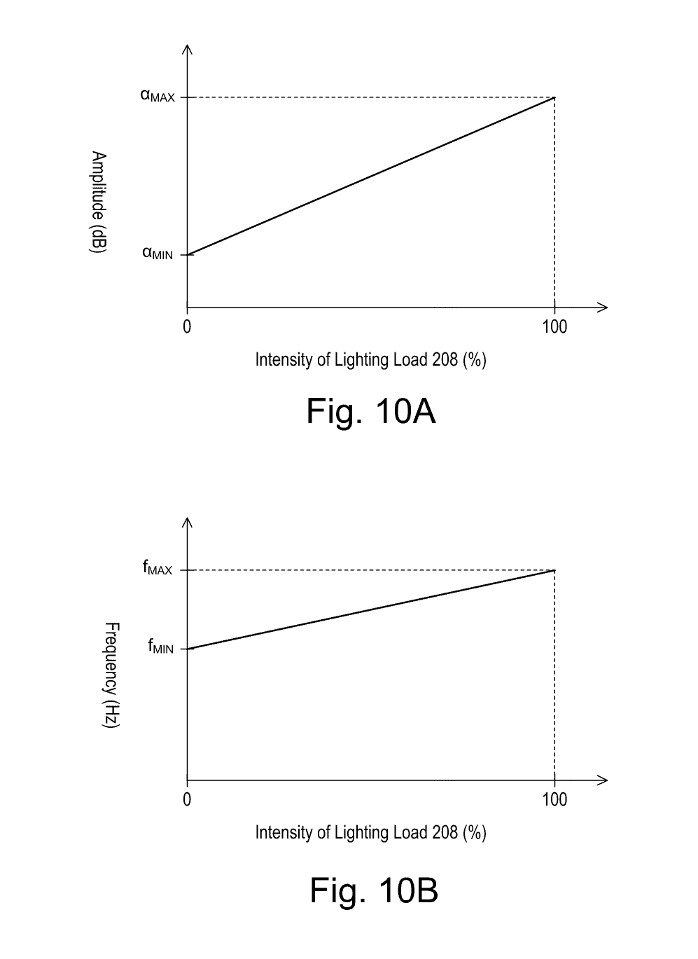

The controller 214 may periodically generate audible sounds in response to actuations of the upper portion of the front surface 108, where the audible sounds increase in amplitude (i.e., volume) as the lighting intensity L of the lighting load 208 increases, and decrease in amplitude as the intensity of the lighting load 208 decreases. Each of the audible sounds may last for a predetermined period of time T_{SND}, e.g., approximately 0.5 second. FIG. 10A is a plot of the amplitude of the audible sounds generated by the audible sound generator 240 as a function of the lighting intensity L of the lighting load 208. As shown in FIG. 10A, the amplitude varies linearly with respect to the lighting intensity L of the lighting load 208 and ranges from a minimum amplitude α_{MIN} to a maximum amplitude α_{MAX}. The audible sound generator 240 may be designed such that the magnitude of the speaker sound signal V_{SPKR} results in speaker 248 generating audible sounds having minimum and maximum amplitudes α_{MIN}, α_{MAX} that are loud enough to be heard by a typical user of the dimmer 100, but are not too loud so as to be disturbing to the user.

Alternatively, the frequency of the audible sounds may be varied in response to the lighting intensity L of the lighting load 208. For example, the controller 214 may increase the frequency of the audible sounds as the lighting intensity L of the lighting load 208 increases, and decrease the frequency as the lighting intensity L of the lighting load decreases. FIG. 10B is a plot of the frequency of the audible sounds generated by the audible sound generator 240 as a function of the lighting intensity L of the lighting load 208. As shown in FIG. 10B, the frequency varies linearly with respect to the lighting intensity L of the lighting load 208 and ranges from a minimum frequency f_{MIN} (e.g., approximately 262 Hz) to a maximum frequency f_{MAX} (e.g., approximately 440 Hz). According to another alternative embodiment, the audible sounds generated by the audible sound generator 240 could change in both amplitude and frequency as the lighting intensity L of the lighting load 208 changes.

FIGS. 11A-11F are example waveforms as well as plots of the amplitude and the frequency of the audible sounds generated by the audible sound generator with respect to time. When the lighting load 208 is turned from off to on (e.g., by actuating the lower portion of the front surface 108 surrounding the icon 116), the controller 214 may cause the audible sound generator 240 to generate a turn-on audible sound that lasts for a turn-on sound period T_{ON} (e.g., one second) and increases in amplitude with respect to time during the turn-on sound period as shown in FIG. 11A. FIG. 11B shows the amplitude α_{ON}(t) of the turn-on audible sound with respect to time and FIG. 11C shows the frequency α_{ON}(t) of the turn-on audible sound with respect to time. The turn-on audible sound starts at a start time t_{SRT} and ends at an end time t_{END} (i.e., lasting for the first turn-on sound period T_{ON}). As shown in FIG. 11B, the amplitude α_{ON}(t) increases linearly with respect to time, i.e.,

α_{ON}(t)=m·t+α₀, (Equation 1)

where m is the rate at which the amplitude increases and α₀ is the initial amplitude (e.g., approximately 0 dB). The frequency f_{ON}(t) is constant with respect to time, i.e., f_{ON}(t)=f_{ON} (e.g., approximately 440 Hz) as shown in FIG. 11C. Therefore, a turn-on audible sound waveform x_{ON}(t) is defined by the equation

x_{ON}(t)=α_{ON}(t)·sin(f_{ON}(t)·t)=(m·t+α₀)·sin(f_{ON}·t), (Equation 2)

and is shown in FIG. 11A. Alternatively, the amplitude α_{ON}(t) of the turn-on audible sound could increase non-linearly (e.g., exponentially) with respect to time.

When the lighting load 208 is turned from on to off (in response to subsequent actuations of the lower portion of the front surface 108 surrounding the icon 116), the controller 214 may cause the audible sound generator 240 to generate a turn-off audible sound that lasts for a turn-off sound period T_{OFF} (e.g., one second) and decreases in amplitude with respect to time during the turn-off sound period as shown in FIG. 11D. FIG. 11E shows the amplitude α_{OFF}(t) of the turn-off audible sound with respect to time and FIG. 11F shows the frequency f_{OFF}(t) of the turn-off audible sound with respect to time. As shown in FIG. 11E, the amplitude α_{OFF}(t) decreases linearly with respect to time, i.e.,

α_{ON}(t)=α₀−m·t, (Equation 3)

where m is the rate at which the amplitude decreases and α₀ is the initial amplitude (e.g., approximately the maximum amplitude α_{MAX}). A turn-off audible sound waveform x_{OFF}(t) is defined by the equation

x_{OFF}(t)=α_{OFF}(t)·sin(f_{OFF}(t)·t)=(α₀−m·t)·sin(f_{OFF}·t), (Equation 4)

and is shown in FIG. 11D. Alternatively, the amplitude α_{OFF}(t) of the turn-off audible sound could decrease non-linearly (e.g., exponentially) with respect to time.

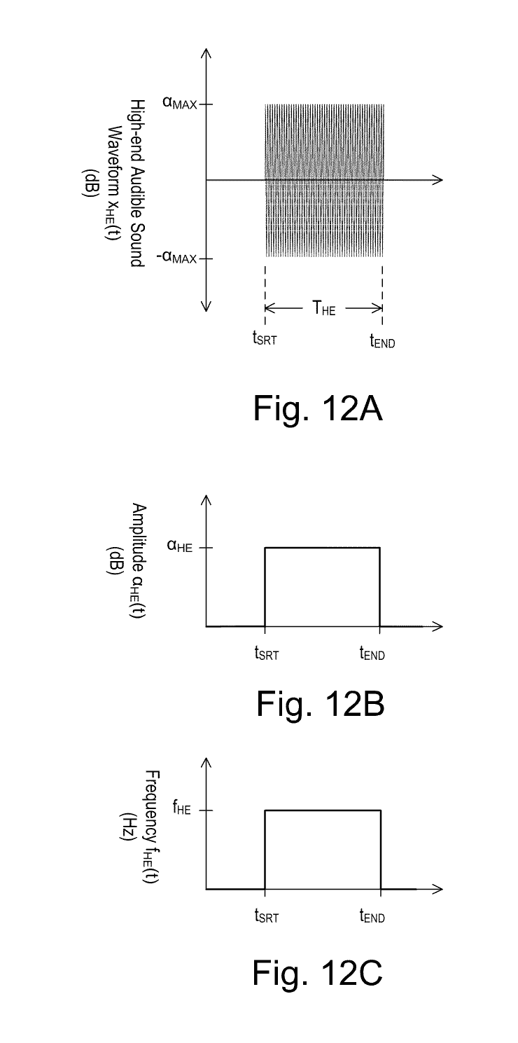

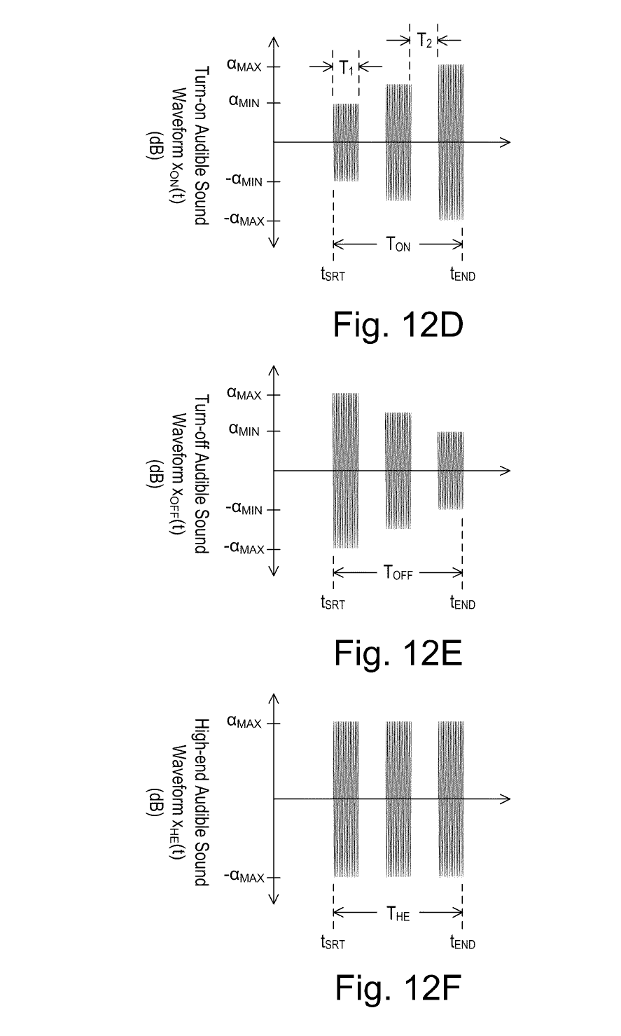

In addition, the controller 214 may cause the audible sound generator 240 to generate a high-end audible sound when the lighting intensity L of the lighting load 208 is controlled to the maximum intensity L_{MAX}. FIGS. 12A-12C show an example waveform as well as plots of the amplitude and the frequency of the high-end audible sound with respect to time. For example, the high-end audible sound may have a constant amplitude α_{LHE} (e.g., equal to the maximum amplitude α_{MAX}) and a constant frequency f_{HE} (e.g., approximately 440 Hz) for the length of a high-end sound period T_{HE} as shown in FIGS. 12B and 12C, respectively. A high-end audible sound waveform x_{HE}(t) is defined by the equation

x_{HE}(t)=α_{HE}·sin(f_{HE}·t), (Equation 5)

and is shown in FIG. 12A.

As shown in FIGS. 11A-11F and FIGS. 12A-12C, the turn-on audible sound, the turn-off audible sound, and the high-end audible sound may comprise continuous audible sounds for the length of the turn-on sound period T_{ON}, turn-off sound period T_{OFF}, and high-end sound period T_{HE}, respectively. Alternatively, the turn-on audible sound, the turn-off audible sound, and the high-end audible sound may each comprise a plurality of consecutive discrete sounds that increase or decrease in frequency during the turn-on sound period T_{ON}, turn-off sound period T_{OFF}, and high-end sound period T_{HE}, respectively.

FIGS. 12D-12F are plots of example waveforms of the turn-on audible sound, the turn-off audible sound, and the high-end audible sound, respectively, when each sound comprises a number N of consecutive discrete sounds. For example, the turn-on audible sound comprises three discrete sounds that each last for a first period of time T₁ (e.g., approximately 0.25 second). Each consecutive audible sound is a second period of time T₂ (e.g., approximately 0.25 second) apart from each other, such that the turn-on sound period T_{ON} is

T_{ON}=N·T₁+(N−1)·T₂, (Equation 6)

e.g., approximately 1.25 seconds. Each consecutive audible sound increases in amplitude (with respect to the previous discrete sound). For example, the first audible sound may have a constant amplitude equal to the minimum amplitude α_{MIN} and the third audible sound may have a constant amplitude equal to the maximum amplitude α_{MAX}, while the second audible sound may have a constant amplitude at the midpoint between the minimum amplitude α_{MIN} and the maximum amplitude α_{MAX}. The turn-off audible sound comprises, for example, three discrete sounds that decrease in amplitude as shown in FIG. 12E. The high-end audible sound comprises, for example, three discrete sounds that have the same amplitude as shown in FIG. 12F.

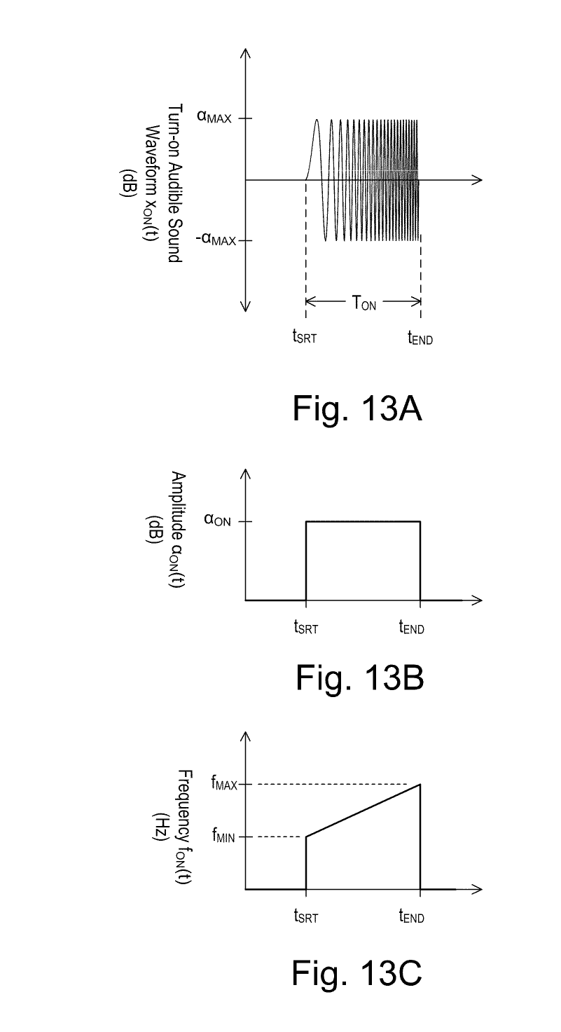

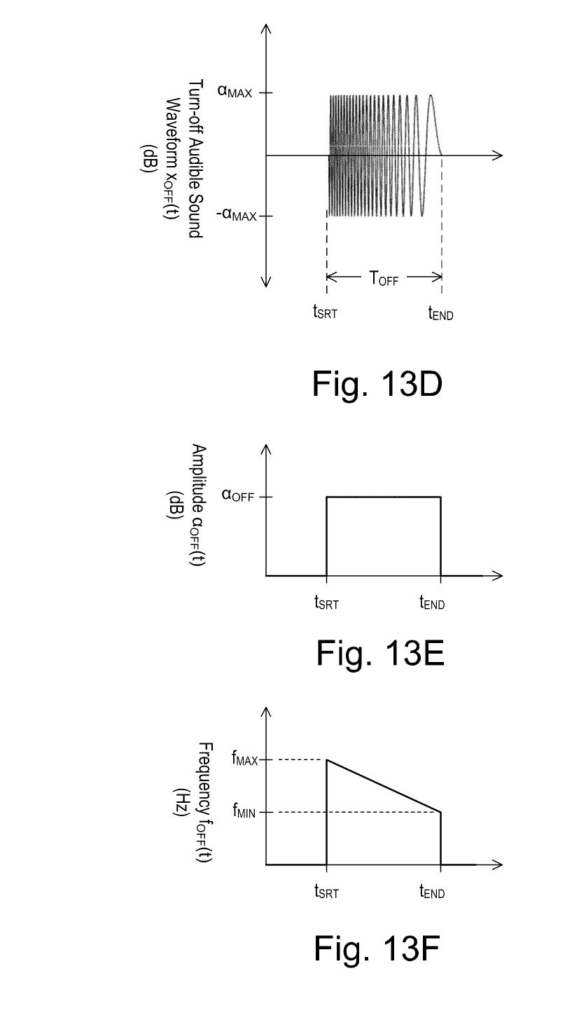

According to another alternative embodiment, the controller 214 may generate audible sounds that vary in frequency with respect to time when the lighting load is turned on or turned off FIGS. 13A-13F are example waveforms as well as plots of the amplitude and the frequency of the audible sounds having varying frequencies with respect to time. Such audible sounds that vary in frequency with respect to time are often called “chirps.” FIG. 13B shows the amplitude α_{ON}(t) of the turn-on audible sound with respect to time and FIG. 13C shows the frequency f_{ON}(t) of the turn-on audible sound with respect to time. As shown in FIG. 13C, the frequency f_{ON}(t) increases linearly with respect to time, i.e.,

f_{ON}(t)=k·t+f₀, (Equation 7)

where k is the rate at which the frequency increases and f₀ is the initial frequency (e.g., approximately 262 Hz). The amplitude α_{ON}(t) is constant with respect to time, i.e., α_{ON}(t)=α_{ON} as shown in FIG. 13B. Therefore, a turn-on audible sound waveform x_{ON}(t) is defined by the equation

x_{ON}(t)=α_{ON}(t)·sin(f_{ON}(t)·t)=α_{ON}·sin [(m·t+f₀)·t], (Equation 8)

and is shown in FIG. 13A. Alternatively, the frequency f_{ON}(t) could increase non-linearly (e.g., exponentially) with respect to time.

Similarly, the frequency f_{OFF}(t) of the turn-off audible sound decreases with respect to time for the length of the turn-off sound period T_{OFF} when the lighting load 208 is turned from on to off as shown in FIG. 13D. FIG. 13E shows the amplitude α_{OFF}(t) of the turn-off audible sound with respect to time and FIG. 13F shows the frequency f_{OFF}(t) of the turn-off audible sound with respect to time. A turn-off audible sound waveform x_{OFF}(t) is defined by the equation

x_{OFF}(t)=α_{OFF}(t)·sin(f_{OFF}(t)·t)=α_{OFF}·sin [(f₀−m·t)·t], (Equation 9)

and is shown in FIG. 13D. Alternatively, the frequency f_{OFF}(t) could decrease non-linearly (e.g., exponentially) with respect to time.

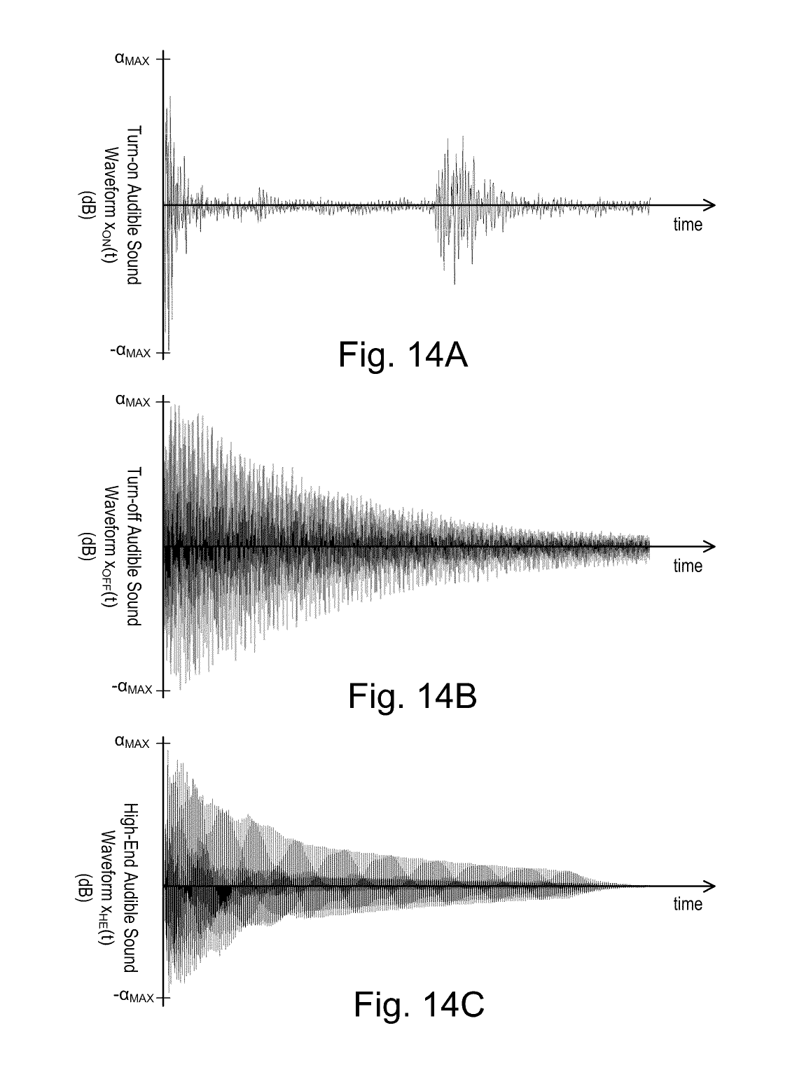

According to yet another alternative embodiment, the turn-on audible sound, the turn-off audible sound, and the high-end audible sound may also comprise common or familiar sounds to convey the resulting operation of the lighting load 208 to the user through sound. For example, the turn-on audible sound could comprise a high-pitch “click” sound as shown in FIG. 14A. The click sound may be similar to the sound that a tactile switch makes when actuated. For example, the controller 214 may control the transistor Q266 of the audio filter 244 to be conductive to increase the cutoff frequency of the audio filter when the audible sound generator 240 is generating the click sound. In addition, the turn-off audible sound could comprise a low-pitch “dong” sound as shown in FIG. 14B and the high-end audible sound could comprise a “strum” sound as shown in FIG. 14C.

According to another embodiment of the present invention, the audible sounds generated by the audible sound generator 240 could comprise voice sounds. These voice sounds could comprise, for example, annunciated words describing the operation of the lighting load 208. For example, the turn-on audible sound, the turn-off audible sound, and the high-end audible sound may comprise the words “on”, “off”, and “full”, respectively. In addition, the voice sounds could annunciate the present lighting intensity L of the lighting load 208 after the user has stopped actuating the touch sensitive device 110, for example, “seventy-five percent” when the lighting intensity L is 75% of the maximum intensity L_{MAX}. The voice sounds could also comprise a mode of operation of the dimmer 100, for example, “vacation mode” or “energy-savings mode”, to indicate that the dimmer is operating in a particular mode. Further, the dimmer 100 could be programmed to produce the voice sounds in different languages that may be selectable by a user, for example, using an advanced programming mode. An advanced programming mode is described in greater detail in commonly-assigned U.S. Pat. No. 7,190,125, issued Mar. 13, 2007, entitled PROGRAMMABLE WALLBOX DIMMER, the entire disclosure of which is hereby incorporated by reference.

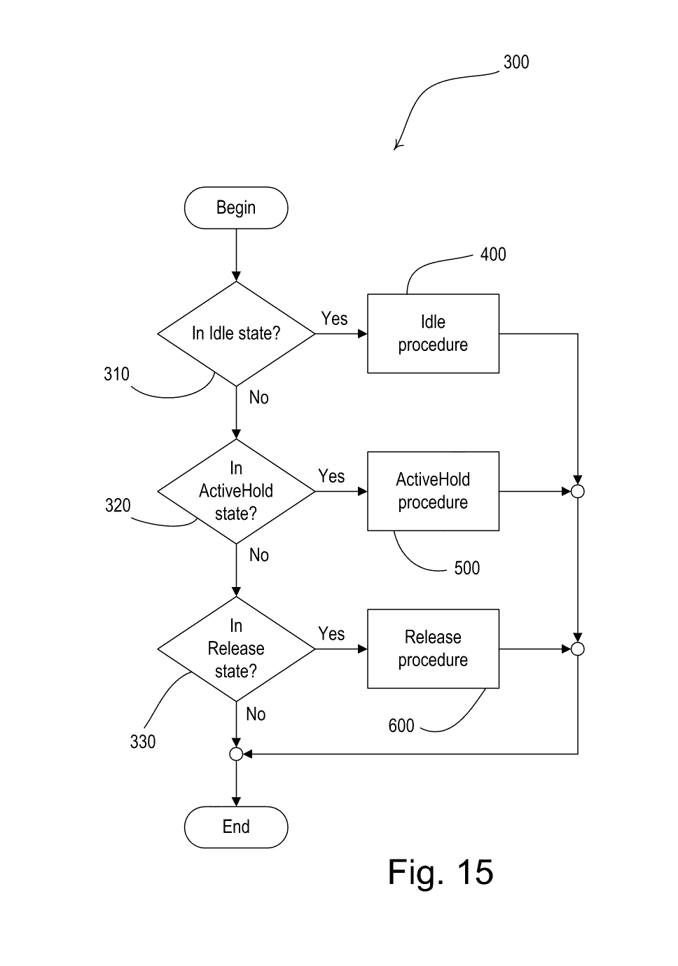

FIG. 15 is a flowchart of a touch dimmer procedure 300 executed by the controller 214 of the dimmer 100. The touch dimmer procedure 300 is called from the main loop of the software of the controller 214, for example, once every half cycle of the AC voltage source 204. The touch dimmer procedure 300 selectively executes one of three procedures depending upon the state of the dimmer 100. If the dimmer 100 is in an “Idle” state (i.e., the user is not actuating the touch sensitive device 110) at step 310, the controller 214 executes an Idle procedure 400. If the dimmer 100 is in an “ActiveHold” state (i.e., the user is presently actuating the touch sensitive device 110) at step 320, the controller 214 executes an ActiveHold procedure 500. If the dimmer 100 is in a “Release” state (i.e., the user has recently ceased actuating the touch sensitive device 110) at step 330, the controller 214 executes a Release procedure 600.

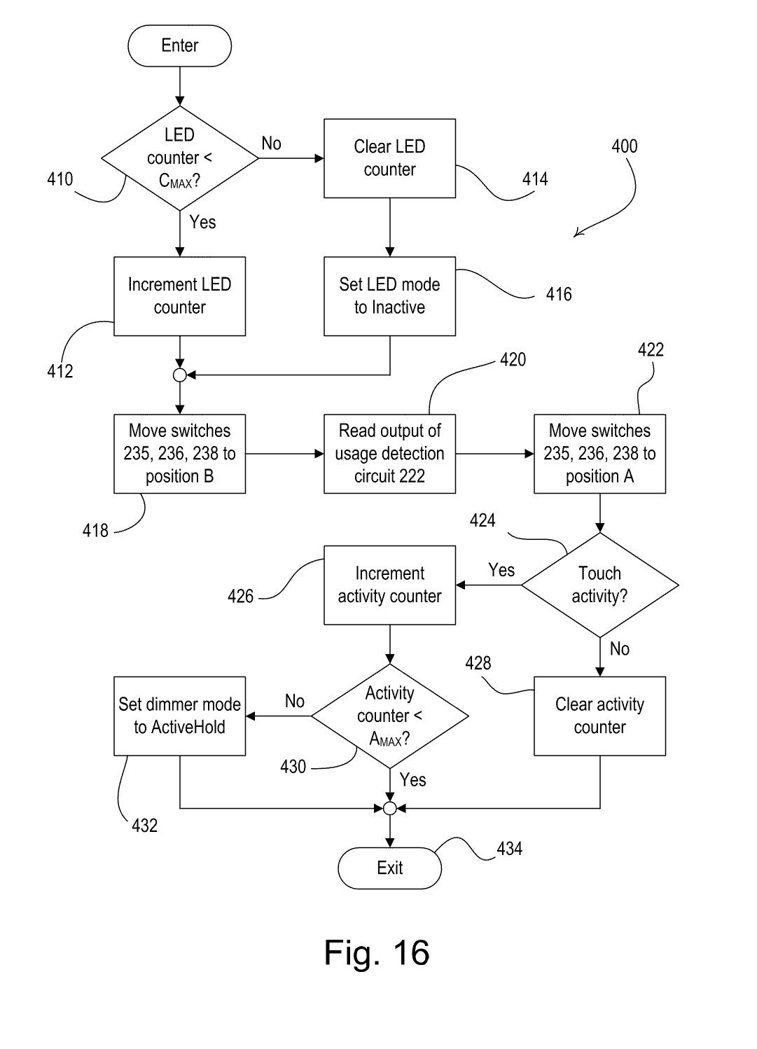

FIG. 16 is a flowchart of the Idle procedure 400 executed by the controller 214 of the dimmer 100. The controller 214 uses an “LED counter” and an “LED mode” to control the status indicators 114 (i.e., the LEDs) of the dimmer 100. The controller 214 uses the LED counter to determine when a predetermined time t_{LED} has expired since the touch sensitive device 110 was actuated. When the predetermined time t_{LED} has expired, the controller 214 will change the LED mode from “active” to “inactive”. When the LED mode is “active”, the status indicators 114 are controlled such that one or more of the status indicators are illuminated to a bright level. When the predetermined time t_{LED} expires, the LED mode is changed to “inactive”, i.e., the status indicators 114 are controlled such that one or more of the status indicators are illuminated to a dim level. Referring to FIG. 16, if the LED counter is less than a maximum LED counter value C_{MAX} at step 410, the LED counter is incremented at step 412 and the process moves on to step 418. However, if the LED counter is not less than the maximum LED counter value C_{MAX}, the LED counter is cleared at step 414 and the LED mode is set to inactive at step 416. Since the touch dimmer procedure 300 is executed once every half cycle, the predetermined time t_{LED} is equal to

t_{LED}=T_{HALF}·C_{MAX}, (Equation 10)

where T_{HALF} is the period of a half cycle.

Next, the controller 214 reads the output of the usage detection circuit 222 to determine if the touch sensitive device 110 is being actuated. For example, the usage detection circuit 222 may be monitored once every half cycle of the voltage source 204. At step 418, the controller 214 controls the switches 235, 236, 238 to position B to couple the resistor R232 and the capacitor C234 to the output of the touch sensitive device 110. The controller 214 determines the DC voltage of the output of the usage detection circuit 222 at step 420, for example, by using an analog-to-digital converter (ADC). Next, the controller 214 controls the switches 235, 236, 238 to position A at step 422 to couple the capacitor C230 to the output of the touch sensitive device 110.

At step 424, if there is activity on the front surface 108 of the dimmer 100, i.e., if the DC voltage determined at step 420 is above a predetermined minimum voltage threshold, then an “activity counter” is incremented at step 426. Otherwise, the activity counter is cleared at step 428. The activity counter is used by the controller 214 to determine if the DC voltage determined at step 420 is the result of a point actuation of the touch sensitive device 110 rather than noise or some other undesired impulse. The use of the activity counter is similar to a software “debouncing” procedure for a mechanical switch, which is well known in the art. If the activity counter is not less than a maximum activity counter value ΔMAX at step 430, then the dimmer state is set to the ActiveHold state at step 432. Otherwise, the process simply exits at step 434.

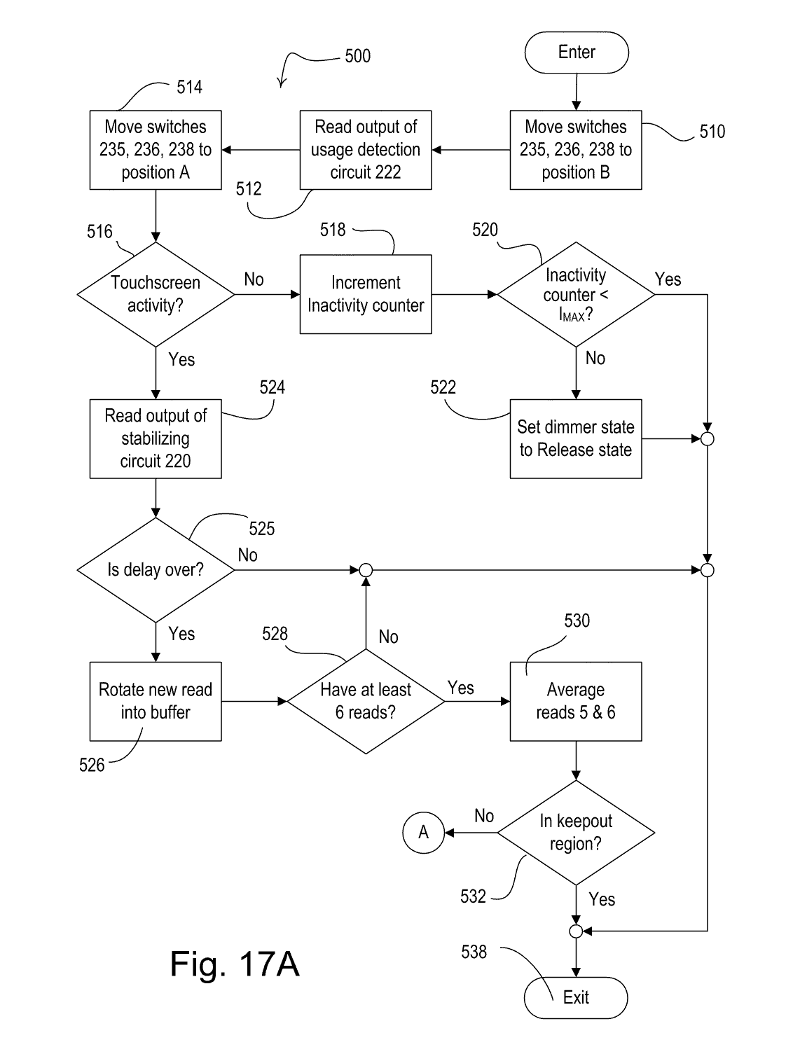

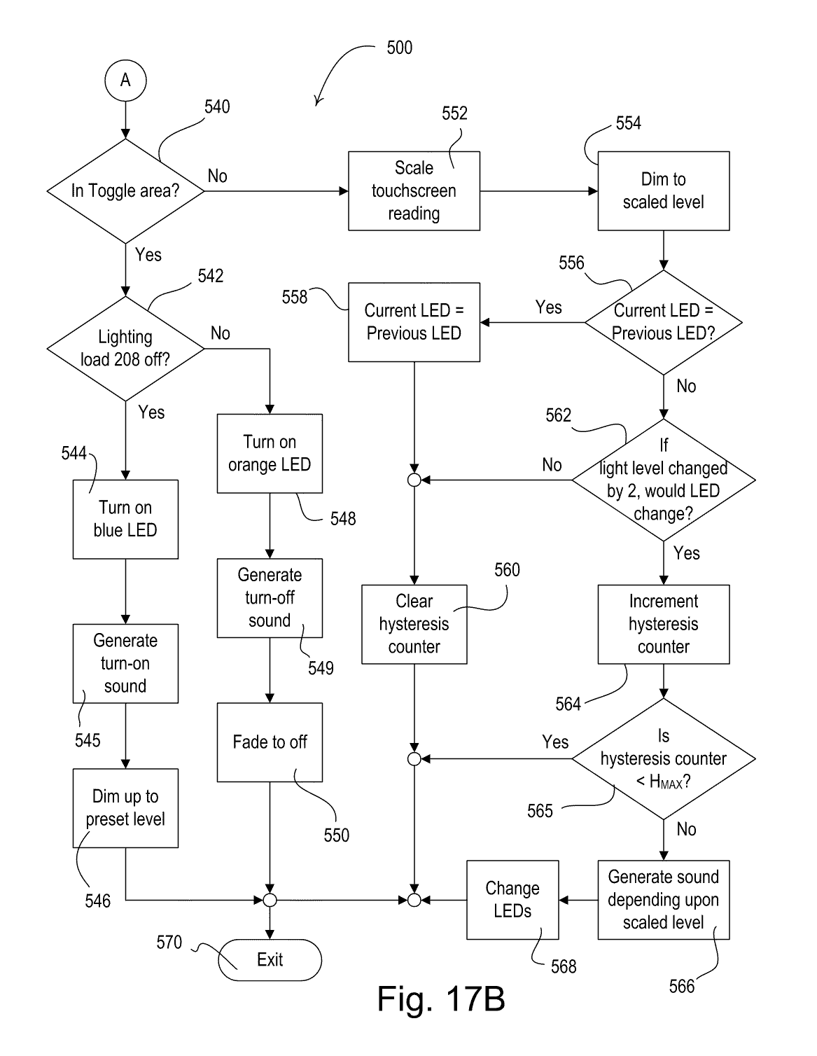

FIGS. 17A and 17B are flowcharts of the ActiveHold procedure 500, which is executed once every half cycle when the touch sensitive device 110 is being actuated, i.e., when the dimmer 100 is in the ActiveHold state. First, a determination is made as to whether the user has stopped using, i.e., released, the touch sensitive device 110. The controller 214 changes the switches 235, 236, 238 to position B at step 510, and reads the output of the usage detection circuit 222 at step 512. At step 514, the controller 214 changes the switches 235, 236, 238 to position A. If there is no activity on the front surface 108 of the dimmer 100 at step 516, the controller 214 increments an “inactivity counter” at step 518. The controller 214 uses the inactivity counter to make sure that the user is not actuating the touch sensitive device 110 before entering the Release mode. If the inactivity counter is less than a maximum inactivity counter value IMAX at step 520, the process exits at step 538. Otherwise, the dimmer state is set to the Release state at step 522, and then the ActiveHold procedure 500 exits at step 538.

If there is activity on the touch sensitive device 110 at step 516, the controller 214 reads the output of the stabilizing circuit 220, which is representative of the position of the point actuation on the front surface 108 of the dimmer 100. Since the switches 235, 236, 238 are in position A, the controller 214 determines the DC voltage at the output of the stabilizing circuit 220 using the ADC at step 524.

Next, the controller 214 uses a buffer to “filter” the output of stabilizing circuit 220. When a user actuates the touch sensitive device 110, the capacitor C230 will charge to approximately the steady-state voltage representing the position of the actuation on the front surface 108 across a period of time determined by the first time constant τ₁ as previously described. Since the voltage across the capacitor C230, i.e., the output of the stabilizing circuit 220, is increasing during this time, the controller 214 delays for a predetermined period of time at step 525, for example, for approximately three (3) half cycles.

When a user's finger is removed from the front surface 108 of the bezel 106, subtle changes in the force and position of the point actuation occur, i.e., a “finger roll-off” event occurs. Accordingly, the output signal of the touch sensitive device 110 is no longer representative of the position of the point actuation. To prevent the controller 214 from processing reads during a finger roll-off event, the controller 214 saves the reads in the buffer and processes the reads with a delay, e.g., six half cycles later. Specifically, when the delay is over at step 525, the controller 214 rotates the new read (i.e., from step 524) into the buffer at step 526. If the buffer has at least six reads at step 528, the controller 214 averages the reads in the fifth and sixth positions in the buffer at step 530 to produce the touch position data. In this way, when the user stops actuating the touch sensitive device 110, the controller 214 detects this change at step 516 and sets the dimmer state to the Release state at step 522 before the controller processes the reads saved in the buffer near the transition time of the touch sensitive device. At step 532, the controller 114 determines if the touch position data from step 530 is in the keepout region 118 (as shown in FIG. 4B). If the touch position data is in the keepout region 118, the ActiveHold procedure 500 simply exits at step 538.

Referring to FIG. 17B, if the touch position data is in the toggle area, i.e., the lower portion of the front surface 108 of the bezel 106 surrounding the icon 116 (as shown in FIG. 4A), at step 540, the controller 214 processes the actuation of the touch sensitive device 110 as a toggle. If the lighting load 208 is presently off at step 542, the controller 214 turns the lighting load on. Specifically, the controller 214 illuminates the icon 116 with the blue status indicator at step 544 and causes the audible sound generator 240 to generate the turn-on audible sound at step 545, for example, using any of the turn-on audible sound waveforms x_{ON}(t) shown in FIGS. 9A-12C. Next, the controller 214 dims the lighting load 208 up to the preset lighting intensity level L_{PRESET} at step 546 and the ActiveHold procedure 500 exits at step 570. If the lighting load is presently on at step 542, the controller 214 turns on the orange status indicator behind the icon 116 at step 548 and causes the audible sound generator 240 to generate the turn-off audible sound at step 549, for example, using any of the turn-off audible sound waveforms x_{OFF}(t) shown in FIGS. 9A-12C. Finally, the controller 214 fades the lighting load 208 to off at step 550 and the ActiveHold procedure 500 exits at step 570.

If the touch position data is not in the toggle area at step 540, the controller 214 scales the touch position data at step 552. The output of the stabilizing circuit 220 is a DC voltage between a maximum value, i.e., substantially the DC voltage V_{CC}, and a minimum value, which corresponds to the DC voltage providing by the touch sensitive device 110 when a user is actuating the lower end of the upper portion of the front surface 108 of the bezel 106. The controller 214 scales this DC voltage to be a value between the minimum intensity L_{MIN} (i.e., 1%) and the maximum intensity L_{MAX} (i.e., 100%) of the lighting load 208. At step 554, the controller 214 dims the lighting load 208 to the scaled level produced in step 552.

Next, the controller 214 changes the status indicators 114 located behind the markers 112 on the front surface 108 of the bezel 106. As a user actuates the touch sensitive device 110 to change the lighting intensity L of the lighting load 208, the controller 214 decides whether to change the status indicator 114 that is presently illuminated. Since there are seven (7) status indicators to present a representation of the lighting intensity L, which may be between 1% and 100%, the controller 214 may illuminate the first status indicator, i.e., the lowest status indicator, to represent an intensity between 1% and 14%, the second status indicator to represent an intensity between 15% and 28%, and so on. The seventh status indicator, i.e., the highest status indicator, may be illuminated to represent an intensity between 85% and 100%. For example, the controller 214 uses hysteresis to control the status indicators 114 such that if the user actuates the front surface 108 at a boundary between two of the regions of intensities described above, consecutive status indicators do not toggle back and forth.

Referring back to FIG. 17B, a determination is made as to whether a change is needed as to which status indicator is illuminated at step 556. If the present LED (in result to the touch position data from step 530) is the same as the previous LED, then no change in the LED is required.

The present LED is set the same as the previous LED at step 558, a hysteresis counter is cleared at step 560, and the ActiveHold procedure 500 exits at step 570.

If the present LED is not the same as the previous LED at step 556, the controller 214 determines if the LED should be changed. Specifically, at step 562, the controller 214 determines if present LED would change if the light level changed by 2% from the light level indicated by the touch position data. If not, the hysteresis counter is cleared at step 560 and the process exits at step 570. Otherwise, the hysteresis counter is incremented at step 564. If the hysteresis counter is less than a maximum hysteresis counter value H_{MAX} at step 565, the process exits at step 570. Otherwise, at step 566, the controller 214 causes the audible sound generator 240 to generate an audible sound, for example, having an amplitude depending upon the touch position data (i.e., the scaled level from step 554) as shown in FIGS. 8A and 8B. The controller 214 then appropriately changes which LEDs are illuminated based on the touch position data at step 568 and the ActiveHold procedure 500 exits at step 570.

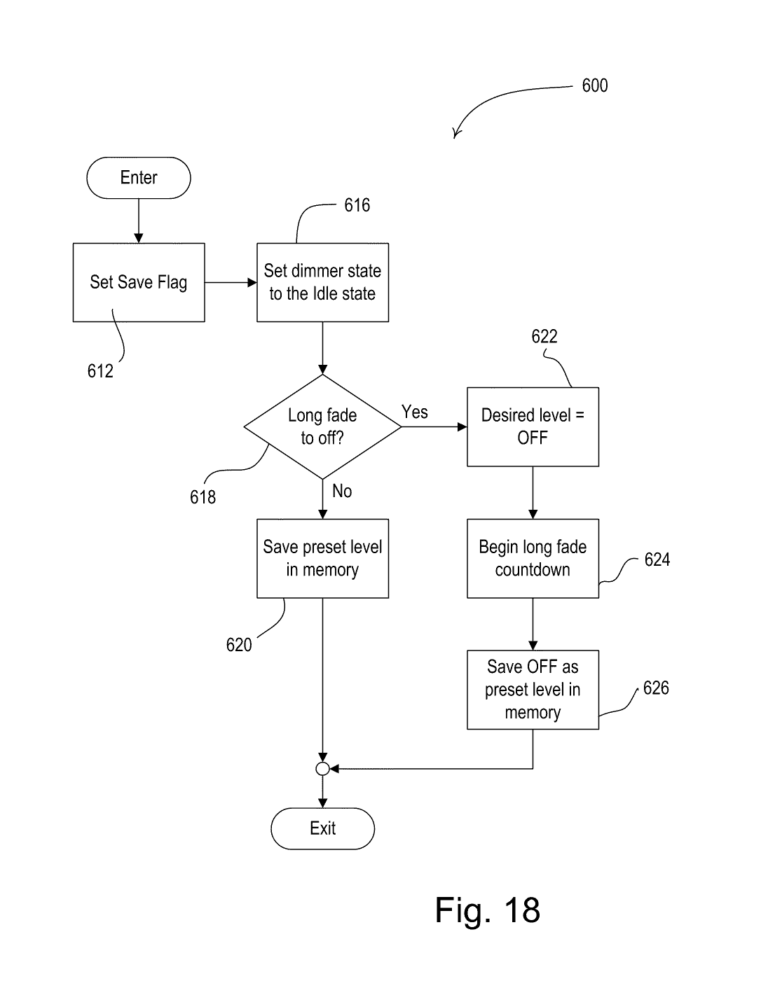

FIG. 18 is a flowchart of the Release procedure 600, which is executed after the controller 214 sets the dimmer state to the Release state at step 522 of the ActiveHold procedure 500. The controller 214 sets a save flag is set at step 612 and sets the dimmer state to the Idle state at step 614. At step 618, a determination is made as to whether the dimmer 100 is presently executed a fade-to-off If not, the present level is saved as the preset level in the memory 224 at step 620. Otherwise, the lighting intensity L is set to off at step 622, the long fade countdown in started at step 624, and the preset level is saved as off in the memory 224.

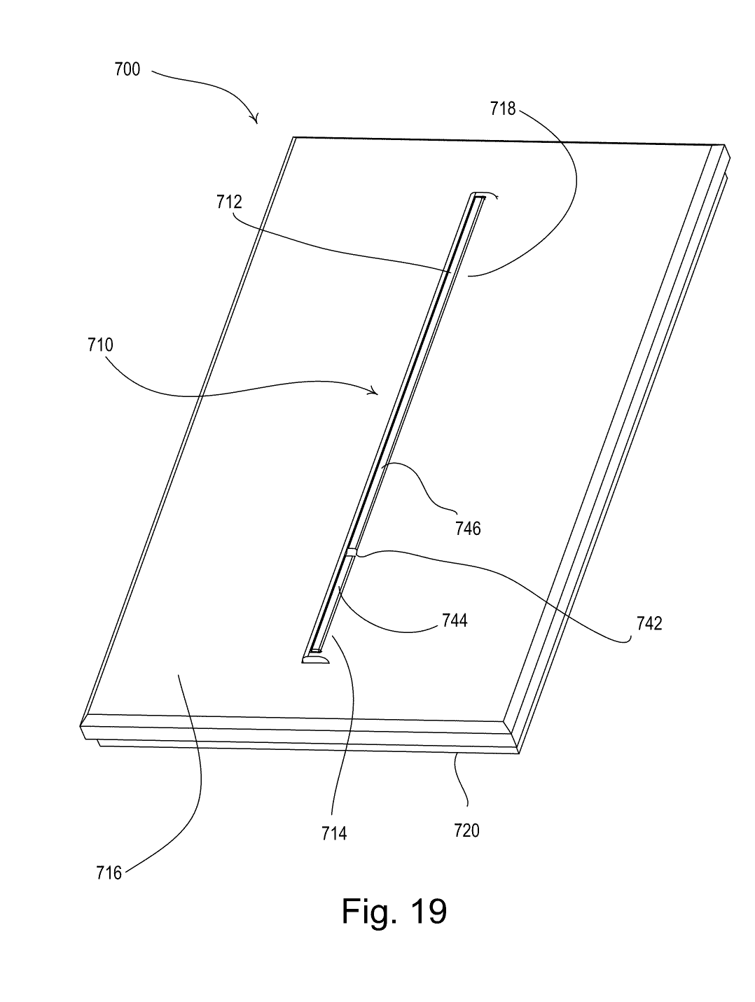

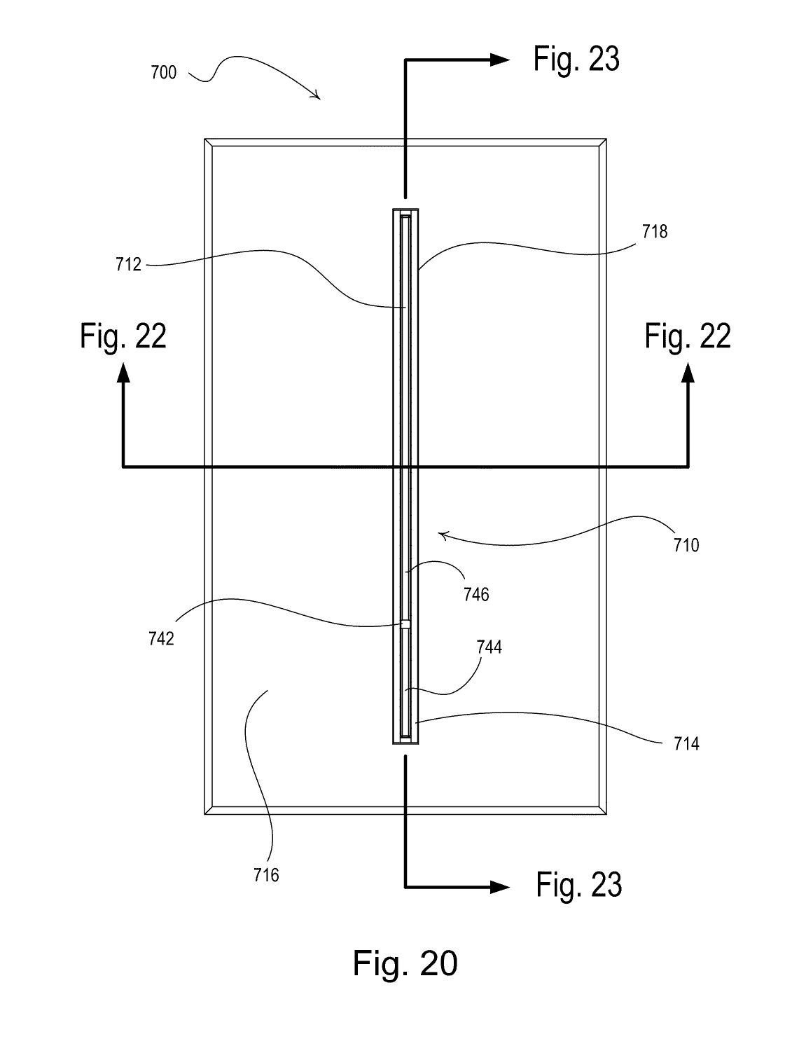

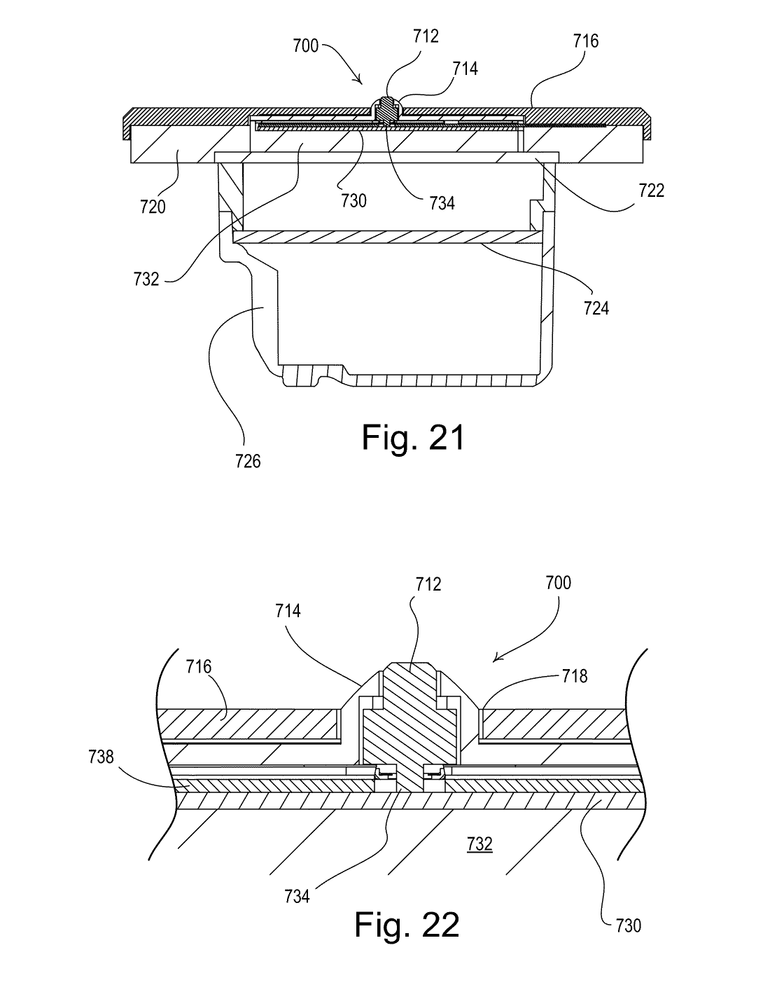

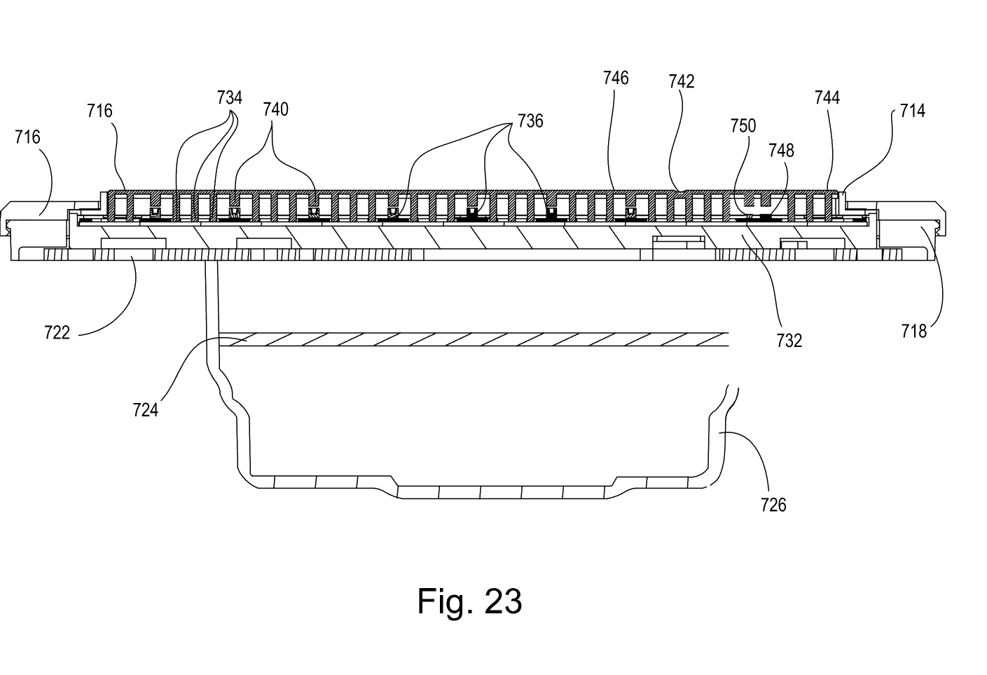

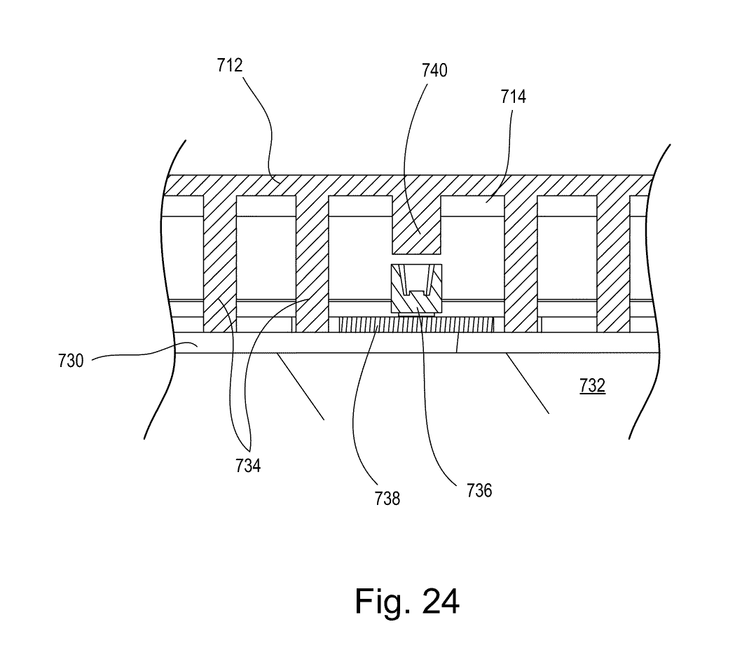

FIG. 19 is a perspective view and FIG. 20 is a front view of a touch dimmer 700 according to a second embodiment of the present invention. FIG. 21 is a bottom cross-sectional view and FIG. 22 is an enlarged partial bottom cross-sectional view of the dimmer 700. FIG. 23 is a left side cross-sectional view and FIG. 24 is an enlarged partial left side cross-sectional view of the dimmer 700.

The touch dimmer 700 includes a thin touch sensitive actuator 710 comprising an actuation member 712 extending through a bezel 714. The dimmer 700 further comprises a faceplate 716, which has a non-standard opening 718 and mounts to an adapter 720. The bezel 714 is housed behind the faceplate 716 and extends through the opening 718. The adapter 720 connects to a yoke 722, which is adapted to mount the dimmer 700 to a standard electrical wallbox. A main printed circuit board (PCB) 724 is mounted inside an enclosure 726 and includes the some of the electrical circuitry of the dimmer 200, e.g., the semiconductor switch 210, the gate drive circuit 212, the controller 214, the zero-crossing detect circuit 216, the power supply 218, the stabilizing circuit 220, the usage detection circuit 222, the audible sound generator 240, and the memory 224, of the dimmer 200. For example, the thin touch sensitive actuator 710 extends beyond the faceplate by approximately 1/16″, i.e., has a height of approximately 1/16″, but may have a height in the range of approximately 1/32″ to 3/32″. The touch sensitive actuator 710 may have a length of approximately 3⅝″ and a width of approximately 3/16″. However, the length and the width of the touch sensitive actuator 710 may be in the ranges of approximately 2⅝″-4″ and ⅛″-¼″, respectively.

The touch sensitive actuator 710 operates to contact a touch sensitive device 730 inside the touch dimmer 700. The touch sensitive device 730 is contained by a base 732. The actuation member 712 includes a plurality of long posts 734, which contact the front surface of the touch sensitive device 730 and are arranged in a linear array along the length of the actuation member. The posts 734 act as force concentrators to concentrate the force from an actuation of the actuation member 712 to the touch sensitive device 730.

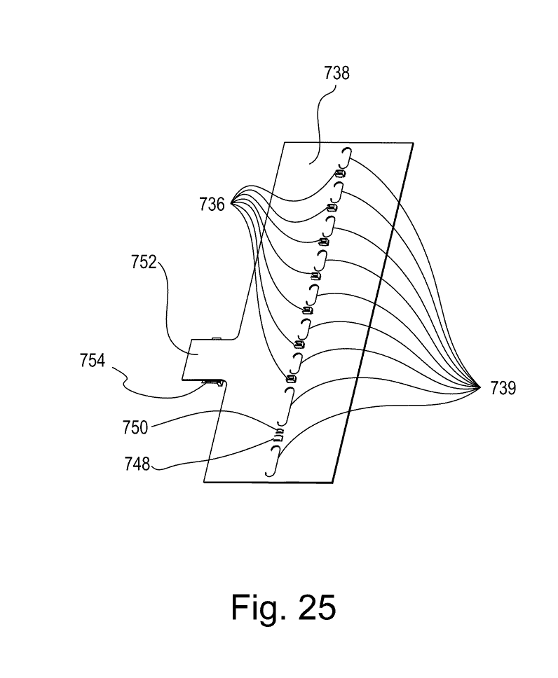

A plurality of status indicators 736 are arranged in a linear array behind the actuation member 712. The status indicators are mounted on a display PCB 738, i.e., a status indicator support board, which is mounted between the touch sensitive device 730 and the bezel 714. FIG. 25 is a perspective view of the display PCB 738. The display PCB 738 includes a plurality of holes 739, which the long posts 734 extend through to contact the touch sensitive device 730. The actuation member 712 is constructed from a translucent material such that the light of the status indicators 736 is transmitted to the surface of the actuation member. A plurality of short posts 740 are provided in the actuation member 712 directly above the status indicators 736 to operate as light pipes for the linear array of status indicators. The display PCB 738 comprises a tab 752 having a connector 754 on the bottom side for connecting the display PCB 738 to the main PCB 724.

The actuation member 712 comprises a notch 742, which separates a lower portion 744 and an upper portion 746 of the actuation member. Upon actuation of the lower portion 744 of the actuation member 712, the dimmer 700 causes the connected lighting load to toggle from on to off (and vice versa). For example, a blue status indicator 748 and an orange status indicator 750 are located behind the lower portion 744, such that the lower portion is illuminated with blue light when the lighting load is on and illuminated with orange light with the lighting load is off. Actuation of the upper portion 746 of the actuation member 712, i.e., above the notch 742, causes the lighting intensity L of the lighting load to change to a level responsive to the position of the actuation on the actuation member 712. The status indicators 736 behind the status markers 112 are illuminated to display a representation of the lighting intensity L of the lighting load as with the touch dimmer 100 of the first embodiment.

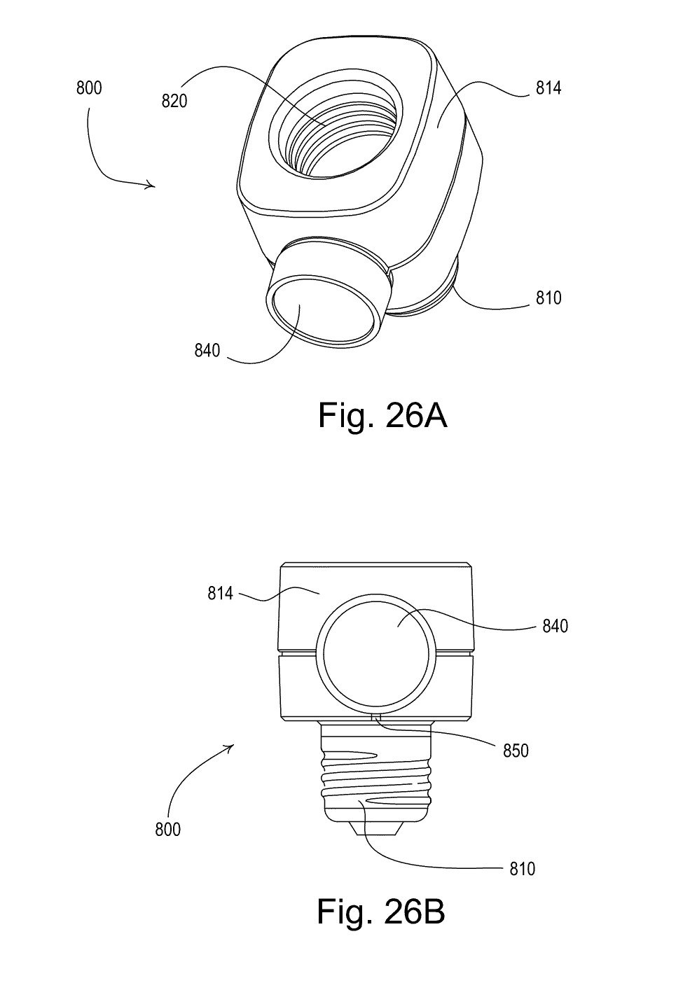

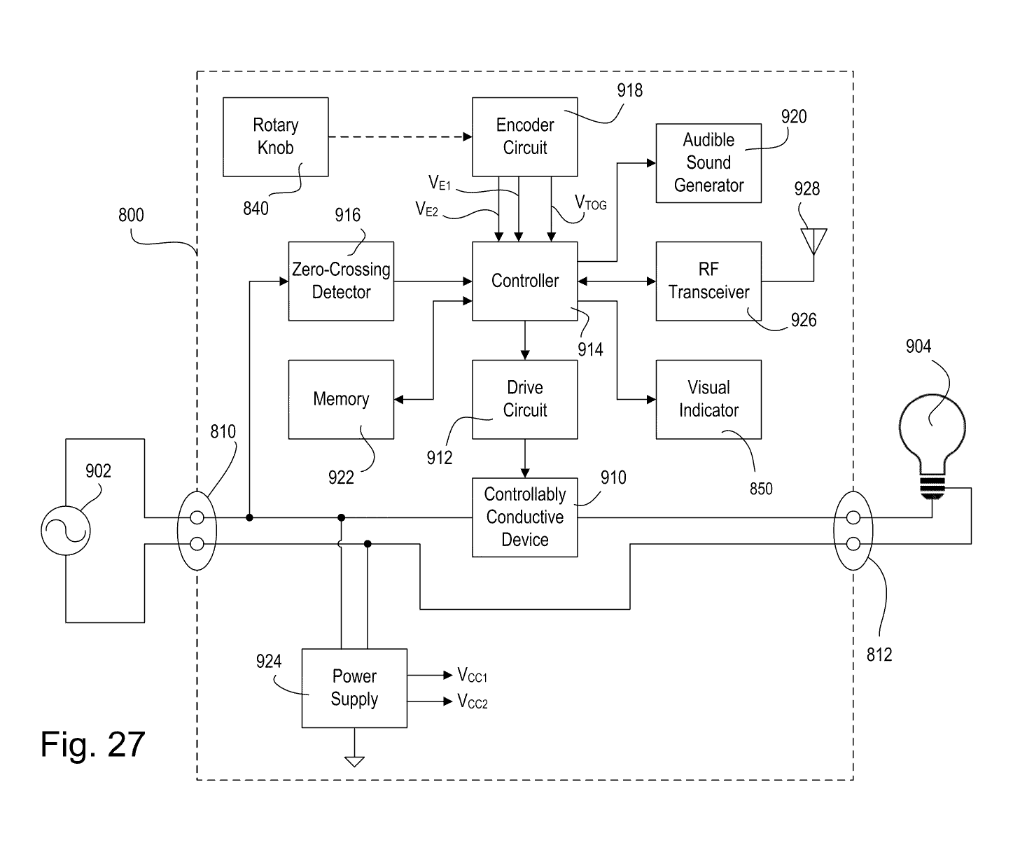

FIG. 26A is a perspective view and FIG. 26B is a front view of a lamp control module 800 according to a third embodiment of the present invention. The lamp control module 800 has a body 814 which contains screw-in base 810, such that the lamp control module is adapted to be screwed into a standard Edison socket. The lamp control module 800 also includes a socket portion 820 (e.g., a standard Edison socket), such that a lighting load 904 (FIG. 27), for example, a standard incandescent lamp, may be coupled to and controlled by the lamp control module. The lamp control module 800 comprises a controllably conductive device 910 (FIG. 27), which is contained within a housing 814 and provides for control of the amount of power delivered to the lighting load 904. When the lamp control module 800 is screwed into a standard Edison socket that is powered by an AC power source 902 (FIG. 27), such as an AC mains voltage (e.g., 120 VAC at 60 Hz), and the lighting load 904 is screwed into the socket portion, the controllably conductive device 910 is coupled in series electrical connection between the AC power source and the lighting load 904 and is rendered conductive and non-conductive to control a intensity level L of the lighting load.

The lamp control module 800 further comprises a rotary intensity adjustment actuator, e.g., a rotary knob 840, which allows a user to adjust of the intensity level L of the lighting load 904. When the user turns the rotary knob 840 clockwise, the intensity level L of the lighting load 904 is increased until the intensity level reaches a maximum (or high-end) intensity level L_{MAX}. As the rotary knob 840 is turned counter-clockwise, the intensity level L of the lighting load 904 is decreased until the intensity level reaches a minimum intensity level (e.g., 1%) and is then turned off. A visual indicator 850, e.g., a light emitting diode (LED), is provided below the rotary knob 840 and is illuminated to provide visual feedback to the user, e.g., to indicate the whether the lighting load 904 is on or off.

The user may also push the rotary knob 840 in towards the housing 814 of the lamp control module 800 to toggle (i.e., turn on and off) the lighting load 904. When the lighting load 904 is turned on in response to a press of the rotary knob 840, the lamp control module 800 may turn the lighting load on to a preset lighting intensity L_{PRESET} (i.e., the lighting intensity L of the lighting load before the lighting load was last turned off). Alternatively, the preset intensity L_{PRESET} could be set to a fixed level, for example, 80%, such that the lighting load 904 is controlled to 80% of the maximum intensity L_{MAX} when the rotary knob 840 is pressed to turn on the lighting load.

The rotary knob 840 is continuously rotatable, such that the user may continue to rotate the rotary knob clockwise after the lighting load 904 has reached the maximum intensity L_{MAX}. In other words, the rotary knob 840 does not have maximum and minimum limits, even though the lighting intensity L of the lighting load 904 is controlled to maximum and minimum intensities. The position of the rotary knob 840 is not representative of the lighting intensity L of the lighting load 904.

The lamp control module 800 is also operable to provide audible feedback to the user. The lamp control module 800 may generate any of the turn-on, turn-off, and high-end audible sounds shown in FIGS. 9A-12C when the lighting load 904 is, respectively, turned on, turned off, and controlled to the maximum intensity L_{MAX}. The lamp control module 800 is operable to repetitively generate the high-end audible sound if the lighting intensity L of the lighting load 904 is at the maximum intensity L_{MAX} and the rotary knob 840 is still being rotated clockwise. The lamp control module 800 is also operable to generate the audible sounds as the rotary knob 840 is rotated. For example, the lamp control module 800 may periodically generate a rotary knob audible sound that lasts for a rotary knob sound period TROT, for example, approximately once every 100 msec as the rotary knob is being rotated. Thus, the lamp control module 800 repetitively generates the rotary knob audible sounds as the rotary knob 840 is rotated. The lamp control module 800 may control the amplitude (or frequency) in response to the present lighting intensity L of the lighting load 904 (as shown in FIGS. 8A and 8B. Alternatively, the lamp control module 800 could generate the rotary knob audible sound whenever the rotary knob 840 has been rotated by a predetermined amount (e.g., approximately 90°).

FIG. 27 is a simplified block diagram of the lamp control module 800 according to the fifth embodiment of the present invention. As shown, the screw-in base 810 is coupled to the AC power source 902 and the lighting load 904 is coupled to the socket portion 820. The controllably conductive device 910 is coupled in series electrical connection between the screw-in base 810 and the socket portion 820 for control of the amount of power delivered to the lighting load 904. The controllably conductive device 910 may comprise any suitable type of bidirectional semiconductor switch, such as, for example, a triac, a field-effect transistor (FET) in a rectifier bridge, or two FETs in anti-series connection. A controller 914 is coupled to a control input of the controllably conductive device 910 via a drive circuit 912, such that the controller is operable to selectively render the controllably conductive device conductive and non-conductive to control the lighting intensity L of the lighting load 904. The controller 914 may be implemented as a microcontroller, but may be any suitable processing device, such as a programmable logic device (PLD), a microprocessor, or an application specific integrated circuit (ASIC). The drive circuit 912 may comprise an optocoupler, such that the controller 914 is electrically isolated from the AC power source 902.

A zero-crossing detect circuit 916 determines the zero-crossing points of the AC source voltage from the AC power supply 902. A zero-crossing is defined as the time at which the AC supply voltage transitions from positive to negative polarity, or from negative to positive polarity, at the beginning of each half-cycle. The zero-crossing information is provided as an input to the controller 914. The controller 914 generates the gate control signals to operate the semiconductor switch 910 to thus provide voltage from the AC power supply 902 to the lighting load 904 at predetermined times relative to the zero-crossing points of the AC waveform.

The controller 914 is operable to control the lighting intensity L of the lighting load 904 in response the rotary knob 840 and to illuminate the visual indicator 850 to display feedback to the user of the lamp control module 800. The rotary knob 840 is mechanically coupled to the shaft of a rotary encoder (not shown) of an encoder circuit 918, which may comprise, for example, part number PEC12-2217F-S0024, manufactured by Bourns, Inc. In response to the actuations of the rotary knob 840, the encoder circuit 918 generates three control signals, which are provided to the controller 914. The encoder circuit 918 generates a toggle control signal V_{TOG}, which is representative of the instances when the rotary knob 840 is pushed in, i.e., to toggle the lighting load 904 on and off Specifically, the rotary encoder includes a single-pole single-throw (SPST) momentary mechanical switch, which is actuated to generate the toggle control signal V_{TOG}.

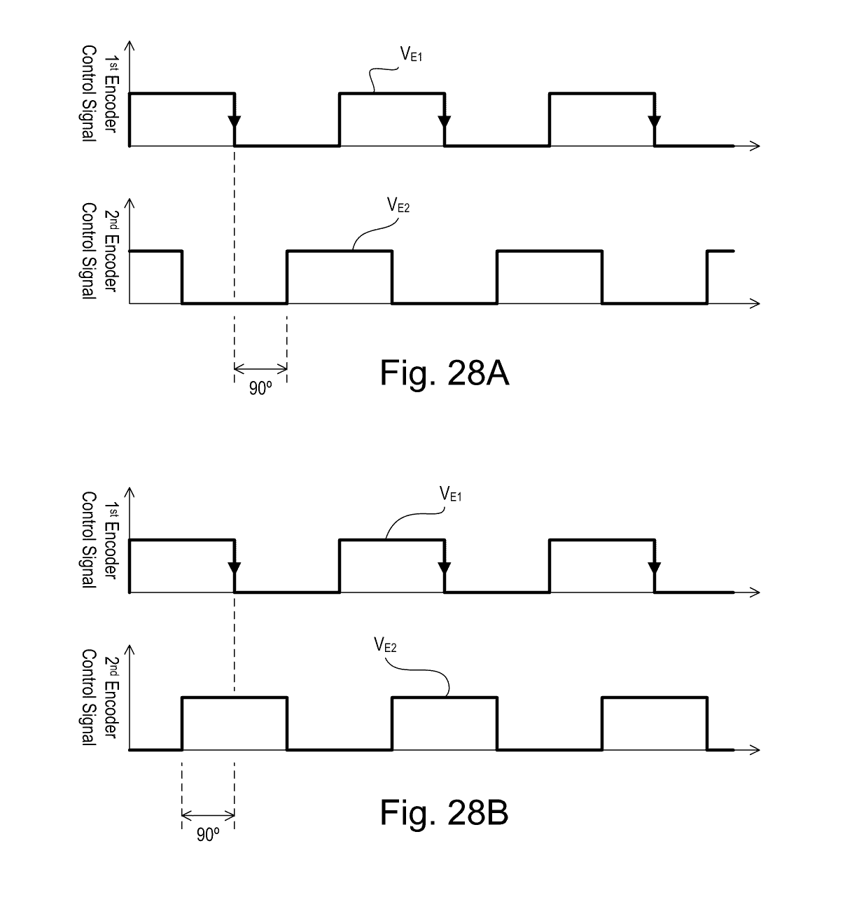

The encoder circuit 918 also generates a first encoder control signal V_{E1} and a second encoder control signal V_{E2}, which are 90° out-of-phase from each other. In combination, the first encoder control signals V_{E1} and the second encoder control signal V_{E2} are representative of the angular velocity ω at which the rotary knob 840 is rotated and the direction (i.e., either clockwise or counter-clockwise) in which the rotary knob is rotated. FIG. 28A is a simplified diagram of the first encoder control signal V_{E1} and the second encoder control signal V_{E2} when the rotary knob 840 is being turned clockwise. FIG. 28B is a simplified diagram of the first encoder control signal V_{E1} and the second encoder control signal V_{E2} when the rotary knob 840 is being turned counter-clockwise. The first encoder control signal V_{E1} lags the second encoder control signal V_{E2} by 90° when the rotary knob 840 is turned clockwise, while the second encoder control signal V_{E2} lags the first encoder control signal V_{E1} by 90° when the rotary knob 840 is turned counter-clockwise. Accordingly, the controller 914 is operable to determine whether the second encoder control signal V_{E2} is low (i.e., at approximately circuit common) or high (i.e., at approximately the first DC voltage V_{CC1}) at the times of the falling edges of the first encoder control signal V_{E1} (i.e., when the first encoder control signal V_{E1} transitions from high to low) to thus determine that the rotary knob 840 is being turned clockwise or counter-clockwise, respectively.

Further, the controller 914 is operable to use the frequency f_{E} of the first encoder control signal V_{E1} to determine how fast the rotary knob 840 is being turned. Specifically, the controller 914 counts the number of falling edges of the first encoder control signal V_{E1} during a predetermined time period T (e.g., every 100 msec) and determines a corresponding intensity change value ΔINT by which to adjust the intensity level L of the lighting load 904. The rotary encoder produces a predetermined number N (e.g., 24) of pulses in each of the first and second encoder control signals V_{E1}, V_{E2} during a full rotation (i.e., 360°) of the rotary knob 840.

The lamp control module 800 further comprises an audible sound generator 920 coupled to the controller 914. The controller is operable to cause the sound generator to produce any of the turn-on, turn-off, and high-end audible sounds shown in FIGS. 11A-14C when the lighting load 904 is turned on, turned off, and controlled to the maximum intensity L_{MAX}, respectively. The lamp control module 800 is also operable to generate the rotary knob audible sounds as the rotary knob 840 is rotated. The audible sound generator 920 may comprise a similar circuit as the audible sound generator 240 of the first embodiment as shown in FIGS. 9A and 9B.

A memory 922 is coupled to the controller 914 and is operable to store control information of the lamp control module 800, such as the preset intensity L_{PRESET} of the lighting load 904. The lamp control module 800 comprises a power supply 924, which generates a first direct-current (DC) voltage V_{CC1} (e.g., approximately 2.8 volts) for powering the controller 914 and the other low-voltage circuitry of the lamp control module, and a second DC voltage V_{CC2} (e.g., approximately 20 volts) for powering the audible sound generator 920. The lamp control module 800 may optionally comprise a communication circuit, e.g., a radio-frequency (RF) transceiver 926 and an antenna 928, such that the controller 914 is operable to transmit and receive digital messages with other control devices as part of a multi-location load control system. Alternatively, other types of communication circuits may be used for transmitting and receiving digital messages on other types of communication links, such as, for example, infrared (IR) communication links, power-line carrier (PLC) communication links, and wired communication links.

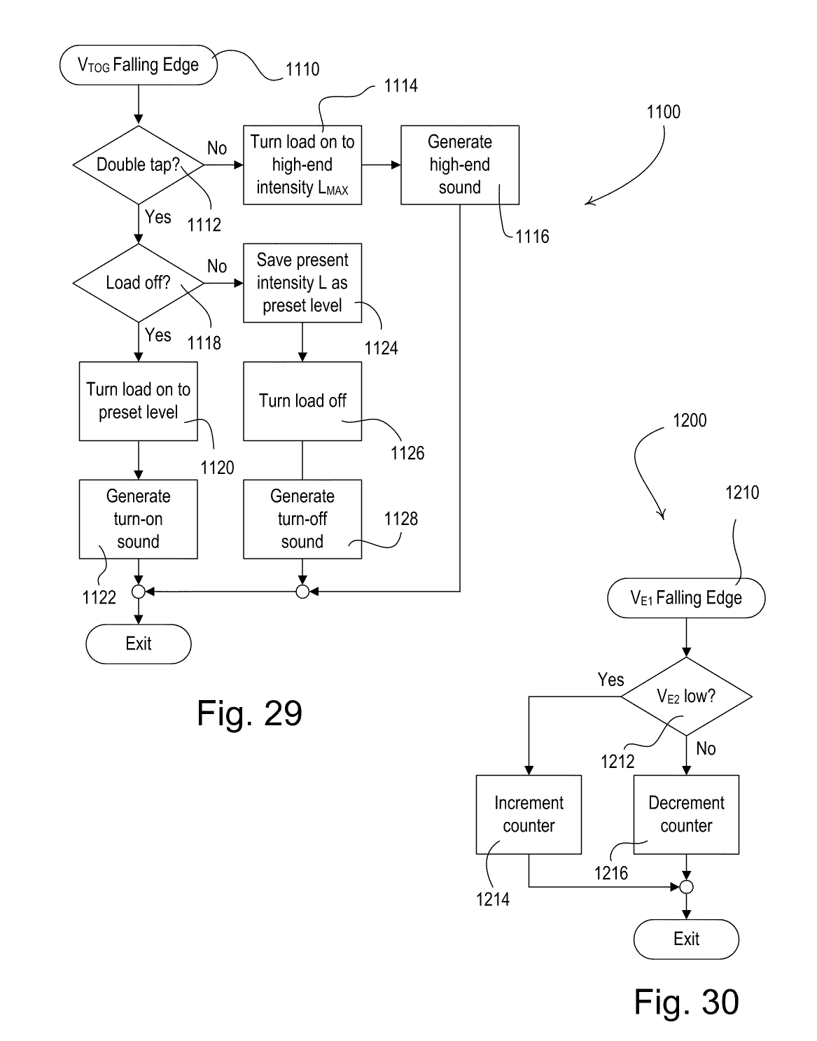

FIG. 29 is a simplified flowchart of a rotary knob press procedure 1100, which is executed by the controller 914 in response to a falling edge of the toggle control signal V_{TOG} at step 1110 (i.e., in response to actuations of the rotary knob 840). If the controller 914 determines that the rotary knob 840 was double-tapped (i.e., two transitory actuations of the rotary knob in quick succession) at step 1112, the controller turns the lighting load 904 on to the maximum intensity L_{MAX} at step 1114 and generates the high-end audible sound at step 1116, before the rotary knob press procedure 1100 exits. The controller 914 may generate the high-end audible sound at step 1116 using, for example, either of the high-end audible sound waveforms x_{HE}(t) shown in FIGS. 10A and 10F.

If the rotary knob 840 was not double-tapped at step 1112 (i.e., the rotary knob was pressed once) and the lighting load 904 is presently off at step 1118, the controller 914 turns the lighting load on to the preset intensity L_{PRESET} stored in the memory 922 at step 920 and generates the turn-on audible sound at step 1122, before the press procedure 1100 exits. The controller 914 may generate the turn-on audible sound at step 1122 using, for example, any of the turn-on audible sound waveforms x_{ON}(t) shown in FIGS. 11A-14C. Otherwise, if the lighting load 904 is presently on at step 1118, the controller 914 stores the present lighting intensity L as the preset intensity L_{PRESET} in the memory 922 at step 1124, and turns the lighting load 904 off at step 1126. The controller 914 then generates the turn-off audible sound at step 1128, and the press procedure 1100 exits. The controller 914 may generate the turn-off audible sound at step 1128 using, for example, any of the turn-off audible sound waveforms x_{OFF}(t) shown in FIGS. 11A-14C.

FIG. 30 is a simplified flowchart of a count procedure 1200, which is executed by the controller 914 in response to a falling edge of the first encoder control signal V_{E1} at step 1210. The controller 914 uses a counter to keep track of the number of falling edges (i.e., the number of pulses) of the first encoder control signal V_{E1} that have occurred during the predetermined timer period T to determine how fast the rotary knob 840 is being turned. If the second encoder control signal V_{E2} is low at step 1212 (i.e., the rotary knob 840 is being turned clockwise), the controller 914 increments the counter by one at step 1214 and the count procedure 1200 exits. Otherwise, if the rotary knob 840 is being turned counter-clockwise at step 1212, the controller 914 decrements the counter by one at step 1216, before the count procedure 1200 exits.

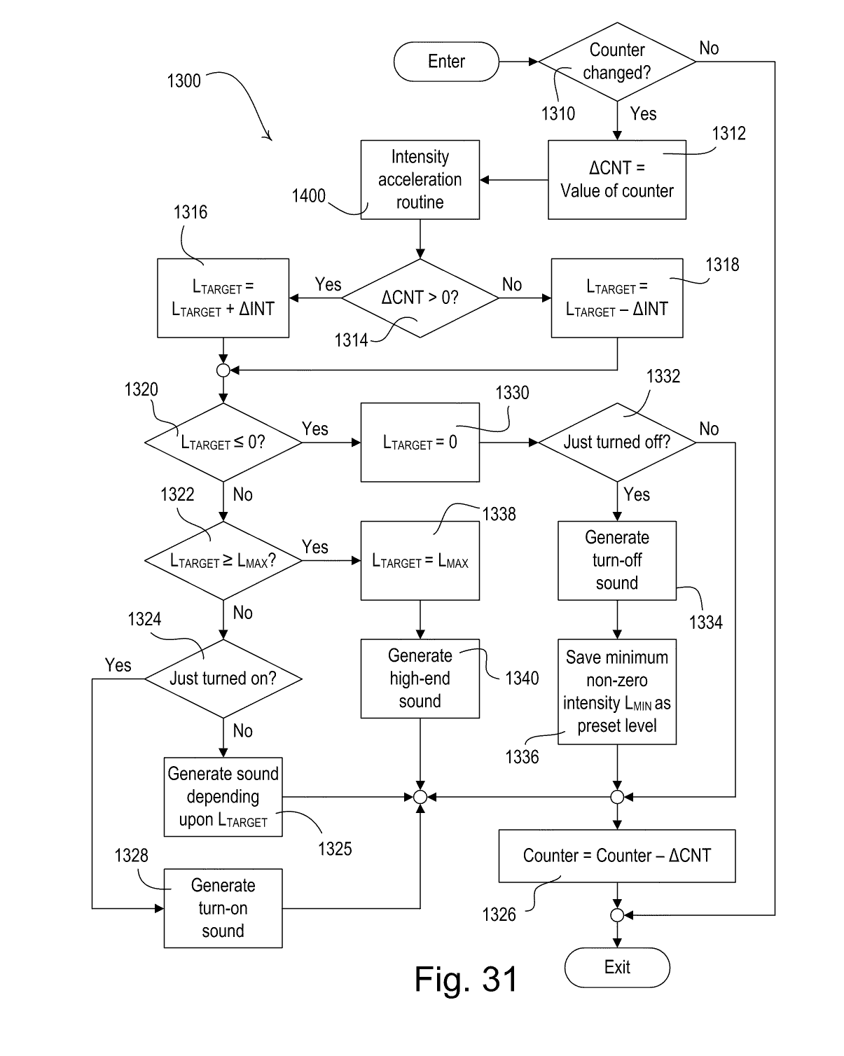

FIG. 31 is a simplified flowchart of an intensity adjustment procedure 1300 executed periodically by the controller 914 (e.g., at the beginning of each predetermined time period T, i.e., every 100 msec). If the counter has not changed in value at step 1310 since the last time that the intensity adjustment procedure 1300 was executed, the intensity adjustment procedure 1300 simply exits. However, if the counter has changed in value at step 1310 since the last execution of the intensity adjustment procedure 1300, the controller 914 analyzes the number of falling edges of the first encoder control signal V_{E1} that occurred in the last time period T (i.e., in the last 100 msec). Specifically, at step 1312, the controller 914 reads the value of the counter and stores this value in a variable ΔCNT for use during the intensity adjustment procedure 1300. Since the value of the counter is recorded at the beginning of each predetermined time period T, the counter value ΔCNT is representative of the angular velocity ω of the rotary knob 840, i.e., ω=[(ΔCNT/N)·360°]/T.

The controller 914 executes an intensity acceleration routine 700 to determine the intensity change value ΔINT in response to the counter value ΔCNT. During the intensity acceleration routine 1600, the controller 914 applies an appropriate acceleration to the intensity change value ΔINT in response to how quickly the rotary knob 840 is being turned. After the intensity acceleration routine 1600 is executed, the intensity change value ΔINT is added to or subtracted from a target intensity L_{TARGET}, which is used to determine the actual amount of power delivered to the lighting load 904. The target intensity L_{TARGET} comprises an integer between 0 (when the lighting load 904 is off) and 255 (when the lighting load is at the maximum intensity L_{MAX}). Since the lighting load 904 is controlled to the target intensity L_{TARGET} once each predetermined time period T and the target intensity L_{TARGET} is determined from the counter value ΔCNT, the rate of change dL/dt of the lighting intensity L of the lighting load is dependent upon the angular velocity ω of the rotary knob 840.

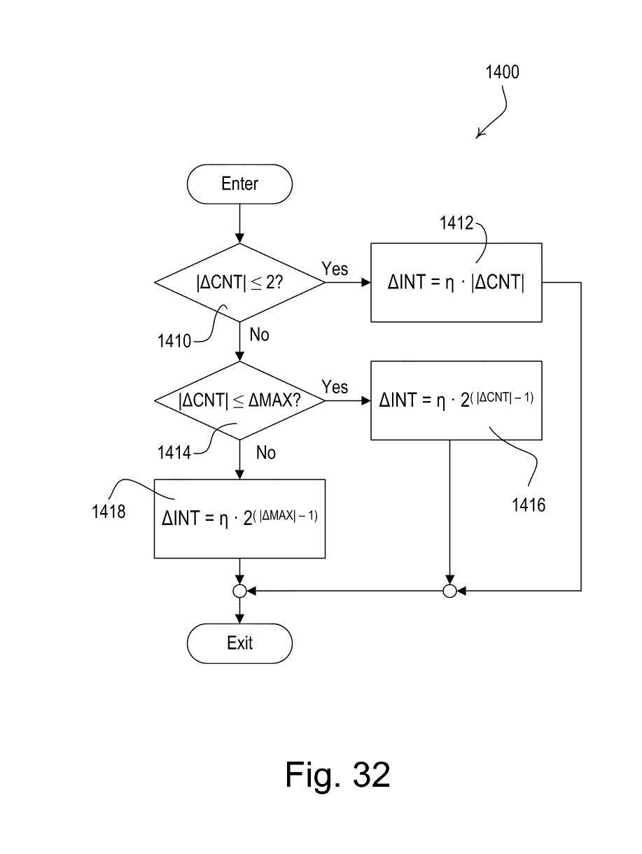

FIG. 32 is a simplified flowchart of the intensity acceleration routine 1400. If the absolute value of the counter value ΔCNT is less than or equal to two (2) at step 1410, the intensity change value ΔINT is set equal to a constant η times the absolute value of the counter value ΔCNT at step 1412. For example, the constant η may equal eight. After the intensity change value ΔINT is set at step 1412, the routine 1400 exits. If the absolute value of the counter value ΔCNT is greater than two (2) at step 1410, but is less than or equal to a maximum counter change value ΔMAX, e.g., six (6), at step 1414, the controller 214 applies the acceleration to the desired intensity change value ΔINT. Specifically, at step 1416, the intensity change value ΔINT is computed as follows:

ΔINT=η·2^{(|ΔCNT|-1)}, (Equation 11)

and the intensity acceleration routine 1400 exits. In other words, the intensity change value ΔINT is set equal to the constant η times two to the power of the quantity (|ΔCNT|−1) at step 1416. If the absolute value of the counter value ΔCNT is greater than the maximum counter change value ΔMAX at step 1414, the intensity change value ΔINT is limited to:

ΔINT=η·2^{(|ΔMAX|-1)}, (Equation 12)

at step 1418, before the intensity acceleration routine 1400 exits. In other words, the intensity change value ΔINT is set equal to the constant η times two to the power of the quantity (|ΔMAX|−1) at step 1418.

Alternatively, during the intensity acceleration routine 1400, the controller 914 could use a lookup table to determine the intensity change value ΔINT. For example, if the constant η equals eight (8), the controller 914 could use the absolute value of the counter value ΔCNT as the index in the following table to determine the intensity change value ΔINT.

| \|ΔCNT\| | ΔINT |
|---|---|
| 1 | 8 |
| 2 | 16 |
| 3 | 32 |
| 4 | 64 |
| 5 | 128 |
| ≧6 | 255 |

Referring back to FIG. 31, after executing the intensity acceleration routine 1400, the intensity change value ΔINT is applied to the target intensity L_{TARGET}. Specifically, if the counter value ΔCNT is greater than zero (i.e., positive) at step 1314, the target intensity L_{TARGET} is set equal to the target intensity L_{TARGET} plus the intensity change value ΔINT at step 1316. Otherwise, if the counter value ΔCNT is negative at step 1314, the target intensity L_{TARGET} is set equal to the target intensity L_{TARGET} minus the intensity change value ΔINT at step 1318.

If the target intensity L_{TARGET} is greater than zero at step 1320 and less than the maximum intensity L_{MAX} (i.e., 255) at step 1322, a determination is made at step 1324 as to whether the lighting load 904 was just turned on. If not, the controller 914 generates at step 1325 the rotary knob audible sound having an amplitude dependent upon the target intensity L_{TARGET} (as shown in FIG. 8A). Alternatively, the controller 914 could generate the rotary knob audible sound at step 1325 using a frequency that is dependent upon the target intensity L_{TARGET} (as shown in FIG. 8B). The controller 914 then subtracts the counter value ΔCNT being used during the present execution of the intensity adjustment procedure 1300 from the counter at step 1326, before the intensity adjustment procedure 1300 exits. Accordingly, the next time that the intensity adjustment procedure 1300 is executed, the controller 914 will consider the change in the value of the counter during the subsequent time period T, i.e., during the subsequent 100 msec.

If the lighting load 904 was just turned on at step 1324, the controller 914 generates the turn-on audible sound at step 1328 and subtracts the counter value ΔCNT from the counter at step 1326, before the intensity adjustment procedure 1300 exits. The controller 914 may generate the turn-on audible sound at step 1328 using, for example, any of the turn-on audible sound waveforms x_{ON}(t) shown in FIGS. 11A-14C.

If the target intensity L_{TARGET} is less than or equal to zero at step 1320 (i.e., the lighting load 904 is off), the controller 914 limits the target intensity L_{TARGET} to zero at step 1330. If the lighting load 904 was not just turned off (during the present execution of the intensity adjustment procedure 1300) at step 1332, the controller 914 subtracts the counter value ΔCNT from the counter at step 1326 and the procedure exits. However, if the lighting load 904 was just turned off at step 1332, the controller 914 generates the second audible sound at step 1334 using, for example, any of the turn-off audible sound waveforms x_{OFF}(t) shown in FIGS. 11A-14C. The controller 914 then stores the minimum intensity L_{MIN}, e.g., 1%, as the preset intensity L_{PRESET} in the memory 922 at step 1336, before the counter value ΔCNT is subtracted from the counter at step 1326 and the procedure 1300 exits.

If the target intensity L_{TARGET} is greater than or equal to the maximum intensity L_{MAX} at step 1322 (i.e., the lamp control module 800 is at the high-end intensity), the target intensity L_{TARGET} is limited to the maximum intensity L_{MAX} at step 1338. The controller 914 then generates the high-end audible sound at step 1340, using, for example, either of the high-end audible sound waveforms x_{HE}(t) shown in FIGS. 12A and 12F. Next, the counter value ΔCNT is subtracted from the counter at step 1326 and the procedure 1300 exits. Accordingly, when rotary knob 890 is being turned (i.e., the counter is changing) and the lamp control module 800 is at the maximum intensity L_{MAX} at step 1340, the controller 914 generates the high-end audible sound each time that the intensity adjustment procedure 1300 is executed, i.e., once every 100 msec, to thus generate the ratcheting sound at a constant frequency f_{CON}.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A load control device for controlling the amount of power delivered from an AC power source to an electrical load, the load control device comprising:
a controllably conductive device adapted to be coupled in series electrical connection between the AC power source and the electrical load for controlling the amount of power delivered to the load;
a controller coupled to a control input of the controllably conductive device, the controller operable to selectively render the controllably conductive device conductive and non-conductive to control the amount of power delivered to the load; and
an audible sound generator responsive to the controller to generate an audible sound having an operational characteristic, the operational characteristic of the audible sound controlled in response to the amount of power being delivered to the load.

2. The load control device of claim 1, wherein the controller causes the audible sound generator to generate a turn-on audible sound when the electrical load is turned on, and a turn-off audible sound when the electrical load is turned off.

3. The load control device of claim 2, wherein the controller causes the audible sound generator to generate a high-end audible sound when the amount of power delivered to the electrical load is controlled to a maximum amount of power that may be delivered to the load.

4. The load control device of claim 3, wherein the operational characteristic of the audible sound comprises an amplitude of the audible sound.

5. The load control device of claim 4, wherein the turn-on audible sound comprises an audible sound that lasts for a turn-on sound period of time and increases in amplitude with respect to time during the turn-on sound period of time, and the turn-off audible sound comprises an audible sound that lasts for a turn-off sound period of time and decreases in amplitude with respect to time during the turn-off sound period of time.

6. The load control device of claim 5, wherein the high-end audible sound comprises an audible sound that lasts for a high-end sound period of time and has a constant amplitude with respect to time during the high-end sound period of time.

7. The load control device of claim 5, wherein the turn-on audible sound and the turn-off audible sound are continuous.

8. The load control device of claim 5, wherein the turn-on audible sound comprises a plurality of discrete consecutive sounds that increase in amplitude, and the turn-off audible sound comprises a plurality of discrete consecutive sounds that decrease in amplitude.

9. The load control device of claim 3, wherein the operational characteristic of the audible sound comprises a frequency of the audible sound.

10. The load control device of claim 9, wherein the turn-on audible sound comprises a chirp sound that lasts for a turn-on sound period of time and increases in frequency with respect to time during the turn-on sound period of time, and the turn-off audible sound comprises a chirp sound that lasts for a turn-off sound period of time and decreases in frequency with respect to time during the turn-off sound period of time.

11. The load control device of claim 10, wherein the high-end audible sound comprises an audible sound that lasts for a high-end sound period of time and has a constant frequency with respect to time during the high-end sound period of time.

12. The load control device of claim 3, wherein the turn-on audible sound, the turn-off audible sound, and the high-end audible sound comprise familiar sounds.

13. The load control device of claim 12, wherein the turn-on audible sound, the turn-off audible sound, and the high-end audible sound comprise a “click” sound, a “dong” sound, and a “strum” sound, respectively.

14. The load control device of claim 3, wherein the turn-on audible sound, the turn-off audible sound, and the high-end audible sound comprise voice sounds.

15. The load control device of claim 1, wherein the operational characteristic of the audible sound comprises an amplitude of the audible sound.

16. The load control device of claim 15, wherein the audible sound increases in amplitude as the amount of power delivered to the load increases, and decreases in amplitude as the amount of power delivered to the load decreases.

17. The load control device of claim 16, further comprising:
an intensity adjustment actuator adapted to be actuated by a user, the controller operable to control the amount of power delivered to the load in response to actuations of the intensity adjustment actuator;
wherein the controller is operable to cause the audible sound generator to generate the audible sound in response to actuations of the intensity adjustment actuator.

18. The load control device of claim 17, wherein the intensity adjustment actuator comprises a rotary knob, the controller responsive to rotations of the rotary knob to increase the amount of power delivered to the load when the rotary knob is rotated in a first direction and to decrease the amount of power delivered to the load when the rotary knob is rotated in a second direction, the controller operable to periodically cause the audible sound generator to generate the audible sound in response to rotations of the rotary knob.

19. The load control device of claim 17, wherein the intensity adjustment actuator comprises a touch sensitive device responsive to a plurality of point actuations at a touch sensitive front surface of the load control device, the controller operable to cause the audible sound generator to generate the audible sound when the touch sensitive device is actuated.

20. The load control device of claim 1, wherein the operational characteristic of the audible sound comprises a frequency of the audible sound.

21. The load control device of claim 20, wherein the audible sound increases in frequency as the amount of power delivered to the load increases, and decreases in frequency as the amount of power delivered to the load decreases.

22. A method of providing feedback of the amount of power delivered from an AC power source to an electrical load, the method comprising the steps of:
adjusting the amount of power being delivered to the load;
generating an audible sound having an operational characteristic; and
controlling the operational characteristic of the audible sound in response to the amount of power being delivered to the load.

23. The method of claim 22, further comprising the steps of:
generating a turn-on audible sound when the electrical load is turned on; and
generating a turn-off audible sound when the electrical load is turned off.

24. The method of claim 23, further comprising the step of:
generating a high-end audible sound when the amount of power delivered to the electrical load is controlled to a maximum amount of power that may be delivered to the load.

25. The method of claim 24, wherein the operational characteristic of the audible sound comprises an amplitude of the audible sound, such that the turn-on audible sound comprises an audible sound that lasts for a turn-on sound period of time and increases in amplitude with respect to time during the turn-on sound period of time, and the turn-off audible sound comprises an audible sound that lasts for a turn-off sound period of time and decreases in amplitude with respect to time during the turn-off sound period of time.

26. The method of claim 24, wherein the operational characteristic of the audible sound comprises a frequency of the audible sound, such that the turn-on audible sound comprises a chirp sound that lasts for a turn-on sound period of time and increases in frequency with respect to time during the turn-on sound period of time, and the turn-off audible sound comprises a chirp sound that lasts for a turn-off sound period of time and decreases in frequency with respect to time during the turn-off sound period of time.

27. The method of claim 22, wherein the operational characteristic of the audible sound comprises an amplitude of the audible sound, and the step of controlling the operational characteristic of the audible sound further comprises increasing the amplitude of the audible sound as the amount of power delivered to the load increases, and decreasing the amplitude of the audible sound as the amount of power delivered to the load decreases.

28. The method of claim 22, wherein the operational characteristic of the audible sound comprises a frequency of the audible sound, and the step of controlling the operational characteristic of the audible sound further comprises increasing the frequency of the audible sound as the amount of power delivered to the load increases, and decreasing the frequency of the audible sound as the amount of power delivered to the load decreases.

29. A load control device for an electrical load, said load control device being connectable between a power source and said load, said load control device comprising:
a controllably conductive circuit for controlling the power supplied to said load from said power source between maximum and minimum values;
a control structure operatively coupled to said controllably conductive circuit for adjusting the power applied to said load at any desired value between and including said maximum and minimum values; and
a non-visual sensory output structure electronically coupled to said control structure for producing a variable human detectable output related to the adjustment of said control structure to indicate at least the direction of the change in power to said load during a change in the power applied to said load due to an adjustment of said control structure.

30. The load control device of claim 29, wherein said sensory output structure is an audible sound generator.

31. The load control device of claim 30, wherein said sensory output structure produces an audible sound having a variable operating characteristic which is continuously functionally related to the increase or decrease of power applied to said load.

32. The load control device of claim 31, wherein said audible sound has a variable volume which is continuously functionally related to the increase or decrease of power applied to said load.

33. The load control device of claim 31, wherein said audible sound has a variable frequency which is continuously functionally related to the increase or decrease of power applied to said load.

34. The load control device of claim 31, wherein said operating characteristic of said audible sound varies as a function of the rate of change of the adjustment of said control structure.

35. The load control device of claim 31, wherein a volume of said audio signal remains constant when the power applied to said load reaches said maximum value.

36. The load control device of claim 29, wherein said load control device is a light dimmer and said load is a dimmable lamp load.

37. A lamp dimmer system for controlling the power delivered to a lamp, said system comprising:
an adjustment control movable between first and second positions to vary the power applied to said lamp between respective first and second conditions; and
a non-visual haptic output to announce the adjustment state of said lamp and to indicate at least the direction of the change in power to said load in response to said adjustment control.

38. The system of claim 37, wherein said haptic output is an audio output having a volume which increases between a first value and a second value as said adjustment control is moved between said first and second positions respectively.

39. The system of claim 37, wherein said haptic output is an audio output having a frequency which increases between a first value and a second frequency as said adjustment control is moved between said first and second positions respectively.

40. A process for operating a lamp dimming system comprising the steps of:
adjusting the power applied to a lamp;
producing an audio output signal containing at least one of a variable volume or variable frequency; and
adjusting at least one of said variable volume or variable frequency in accordance with the step of adjusting of the power applied to a lamp, such that said variable volume or variable frequency is related to the instantaneous power applied to said lamp, whereby increasing and decreasing the power applied to said lamp is respectively accompanied by one of an increasing or decreasing audio volume or audio frequency signal.
